(19) United States
(12) Patent Application Publication
(10) Pub. No.: US 2018/0365300 A1
(43) Pub. Date: Dec. 20, 2018

(54) DATA DISTRIBUTION APPARATUS AND DATA DISTRIBUTION SYSTEM

(71) Applicants: Takehito KUROKO, Kanagawa (JP); Hiroshi KOBAYASHI, Kanagawa (JP); Hitoshi NAMIKI, Kanagawa (JP); Ryouji YAMAMOTO, Kanagawa (JP)

(72) Inventors: Takehito KUROKO, Kanagawa (JP); Hiroshi KOBAYASHI, Kanagawa (JP); Hitoshi NAMIKI, Kanagawa (JP); Ryouji YAMAMOTO, Kanagawa (JP)

(73) Assignee: Ricoh Company, Ltd., Tokyo (JP)

(21) Appl. No.: 15/972,583

(22) Filed: May 7, 2018

(30) Foreign Application Priority Data
Jun. 15, 2017 (JP) 2017-117775

(51) Int. Cl. G06F 17/30

(52) U.S. Cl. CPC G06F 17/30548; G06F 17/30554; G06F 17/3033

(57) ABSTRACT

A data distribution apparatus includes a processor, in communication with a memory, executing a process including generating fusion data by incorporating, in a metadata area in first time series data in a predetermined section, hash data obtained by hashing second time series data in a corresponding section; calculating a signature value according to a plurality of pieces of the fusion data; and outputting the fusion data, the second time series data in the corresponding section, and the signature value.

### CROSS-REFERENCE TO RELATED APPLICATION

The present application claims priority under 35 U.S.C. § 119 to Japanese Patent Application No. 2017-117775, filed on Jun. 15, 2017, the contents of which are incorporated herein by reference in their entirety.

### BACKGROUND OF THE INVENTION

### 1. Field of the Invention

The present invention relates to a data distribution apparatus and a data distribution system.

### 2. Description of the Related Art

In the related art, there is known a distribution technique in which moving imaging data is divided into predetermined sections, and the moving imaging data is distributed by streaming. In addition, there is known a falsification prevention technique of adding a signature to each of the time series data groups (imaging data and voice data) included in the moving imaging data at the time of distribution, in order to assure the authenticity of the moving imaging data at the distribution destination to which the moving imaging data is distributed by streaming.
Patent Document 1: Japanese Unexamined

Patent Application Publication No. 2011-075867

### SUMMARY OF THE INVENTION

An aspect of the present invention provides a data distribution apparatus and a data distribution system, in which one or more of the disadvantages of the related art are reduced.

According to one aspect of the present invention, there is provided a data distribution apparatus comprising a first processor, in communication with a first memory, executing a first process including generating fusion data by incorporating, in a metadata area in first time series data in a predetermined section, first hash data obtained by hashing second time series data in a corresponding section; calculating a signature value according to a plurality of pieces of the fusion data; and outputting the fusion data, the second time series data in the corresponding section, and the signature value.

### BRIEF DESCRIPTION OF THE DRAWINGS

FIG. 1 is a diagram illustrating an example of a system configuration of a data distribution system according to a first embodiment of the present invention;

FIGS. 2A to 2C are a first diagram for describing a secret distributed protocol according to the first embodiment of the present invention;

FIG. 3 is a second diagram for describing a secret distributed protocol according to the first embodiment of the present invention;

FIG. 4 is a third diagram for describing a secret distributed protocol according to the first embodiment of the present invention;

FIG. 5 is an example of a hardware block diagram of a data distribution apparatus according to the first embodiment of the present invention;

FIG. 6 is an example of a functional block diagram of the data distributing unit according to the first embodiment of the present invention;

FIG. 7 is an example of a functional block diagram of a distribution data generating unit according to the first embodiment of the present invention;

FIG. 8 is a diagram illustrating a method of generating fusion data according to the first embodiment of the present invention;

FIG. 9 is a diagram illustrating a method of generating distribution data according to the first embodiment of the present invention;

FIG. 10 is a diagram illustrating an example of distribution data output from the distribution data generating unit according to the first embodiment of the present invention;

FIGS. 11A and 11B are flowcharts respectively illustrating the flows of an imaging data acquisition process and a voice data acquisition process according to the first embodiment of the present invention;

FIG. 12 is a flowchart illustrating the flow of a distribution process according to the first embodiment of the present invention;

FIG. 13 is an example of a functional block diagram of a data verifying unit according to the first embodiment of the present invention;

FIG. 14 is a flowchart illustrating the flow of a secret distributed data verification process according to the first embodiment of the present invention;

FIG. 15 is a flowchart illustrating the flow of a voice data verification process according to the first embodiment of the present invention;

FIGS. 16A and 16B are diagrams illustrating examples of loss of secret distributed data or voice data according to the first embodiment of the present invention;

FIGS. 17A through 17D are diagrams illustrating examples of falsification on secret distributed data or voice data according to the first embodiment of the present invention;

FIGS. 18A and 18B are diagrams illustrating setting information that can be changed by an administrator of the data distribution system according to a second embodiment of the present invention;

FIG. 19 is a diagram illustrating another example of the system configuration of the data distribution system according to a third embodiment of the present invention;

FIG. 20 is a diagram illustrating yet another example of the system configuration of the data distribution system according to the third embodiment of the present invention; and

FIG. 21 is a diagram illustrating yet another example of the system configuration of the data distribution system according to the third embodiment of the present invention.

### DETAILED DESCRIPTION OF THE PREFERRED EMBODIMENTS

The falsification prevention technique of the related art has the following problem. Specifically, when a part of the moving imaging data in a predetermined section becomes lost due to a failure in the network, etc., the signature verification cannot be performed at the distribution destination. For this reason, even when the moving imaging data has not actually been falsified, if a data loss occurs during the distribution, the authenticity cannot be assured at the delivery destination.

Furthermore, the falsification prevention technique of the related art also has the following problem. Specifically, when falsification is performed with respect to information indicating the association between imaging data and voice data in a predetermined section, this falsification cannot be detected. For this reason, at the distribution destination, it has not been possible to assure the authenticity of information indicating the association between imaging data and voice data in a predetermined section.

A problem to be solved by an embodiment of the present invention is to assure the authenticity of time series data groups that are distributed by streaming.

Embodiments of the present invention will be described by referring to the accompanying drawings. In the specification and drawings of the embodiments, the elements having substantially the same functions are denoted by the same reference numerals, and overlapping descriptions are omitted.

### First Embodiment

### 1. System Configuration of Data Distribution System—First Embodiment

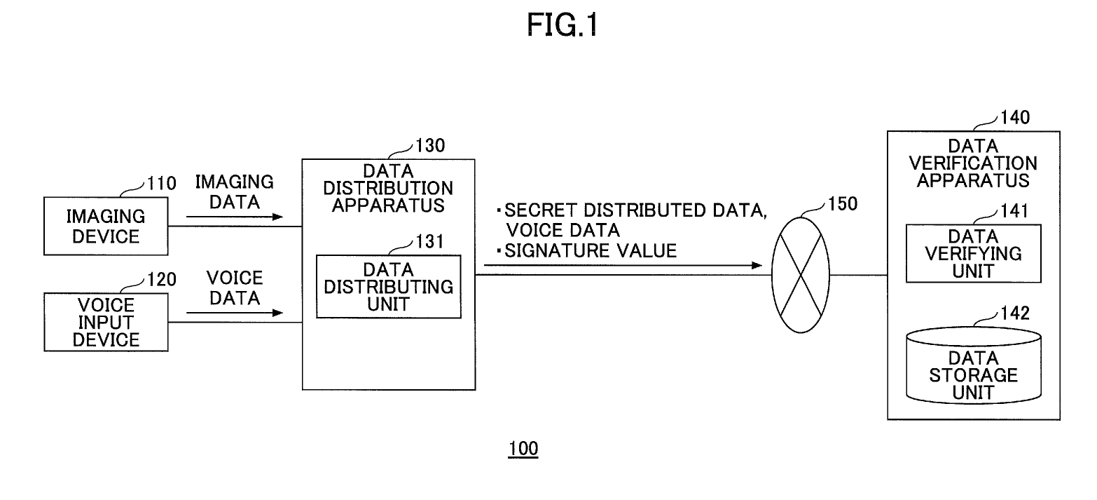

First, the system configuration of a data distribution system will be described. FIG. 1 is a diagram illustrating an example of a system configuration of a data distribution system.

As illustrated in FIG. 1, a data distribution system 100 includes an imaging device 110, a voice input device 120, a data distribution apparatus 130, and a data verification apparatus 140. In the first embodiment, the data distribution apparatus 130 and the data verification apparatus 140 are communicably connected via a network 150.

The imaging device 110 is a device that generates imaging data that is first time series data. The imaging device 110 sequentially transmits the generated imaging data to the data distribution apparatus 130.

The voice input device 120 is a device that generates voice data that is second time series data. The voice input device 120 sequentially transmits the generated voice data to the data distribution apparatus 130.

A data distribution program is installed in the data distribution apparatus 130, and by executing the program, the data distribution apparatus 130 functions as a data distributing unit 131.

The data distributing unit 131 acquires the imaging data (the first time series data) and the voice data (the second time series data), generates distribution data that can assure the authenticity of each time series data item in a predetermined section and the authenticity of information indicating the association between the time series data items in the predetermined section, and distributes the generated distribution data.

Specifically, the data distributing unit 131 generates secret distributed data and a signature value based on a secret distributed protocol by using a plurality of items of imaging data in a predetermined section and voice data in the corresponding section (details will be described later). Furthermore, the data distributing unit 131 distributes the generated secret distributed data and the signature value, and the voice data used for generating the secret distributed data, as distribution data, to the data verification apparatus 140 via the network 150. Note that among the distribution data, the data distributing unit 131 distributes the secret distributed data and the voice data to the data verification apparatus 140 by streaming.

A data verification program is installed in the data verification apparatus 140, and by executing this program, the data verification apparatus 140 functions as a data verifying unit 141.

The data verifying unit 141 receives the secret distributed data, the voice data, and the signature value, as distribution data, from the data distribution apparatus 130, and stores the distribution data in a data storage unit 142. Furthermore, the data verifying unit 141 performs signature verification with respect to the secret distributed data, by using secret information calculated based on the secret distributed data stored in the data storage unit 142 and secret information calculated based on the signature value. Furthermore, the data verifying unit 141 compares the secret distributed data that has undergone the signature verification, with the voice data.

Accordingly, the data verifying unit 141 can assure the authenticity of the imaging data in a predetermined section, the authenticity of voice data in a predetermined section, and the authenticity of information indicating the association between the imaging data and the voice data in the predetermined section.

Note that in the case of secret distributed data, signature verification can be performed by the data verifying unit 141 even if a data loss occurs while the secret distributed data is distribution by streaming from the data distribution apparatus 130. This is because secret distributed data, which has been generated by using a secret distributed protocol, has high resistance with respect to data loss in signature verification.

### 2. Description of Secret Distributed Protocol—First Embodiment

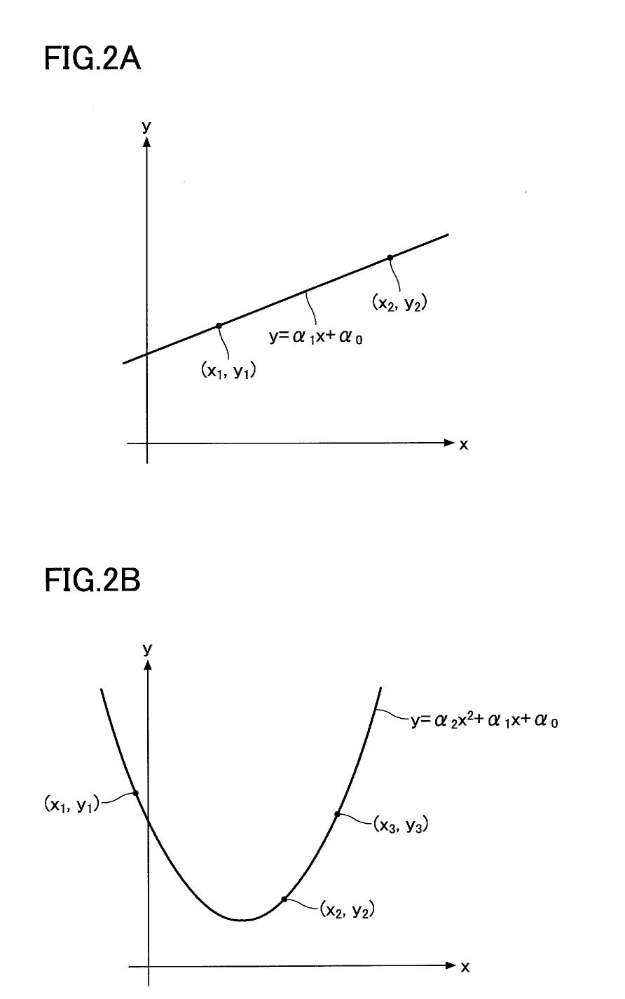

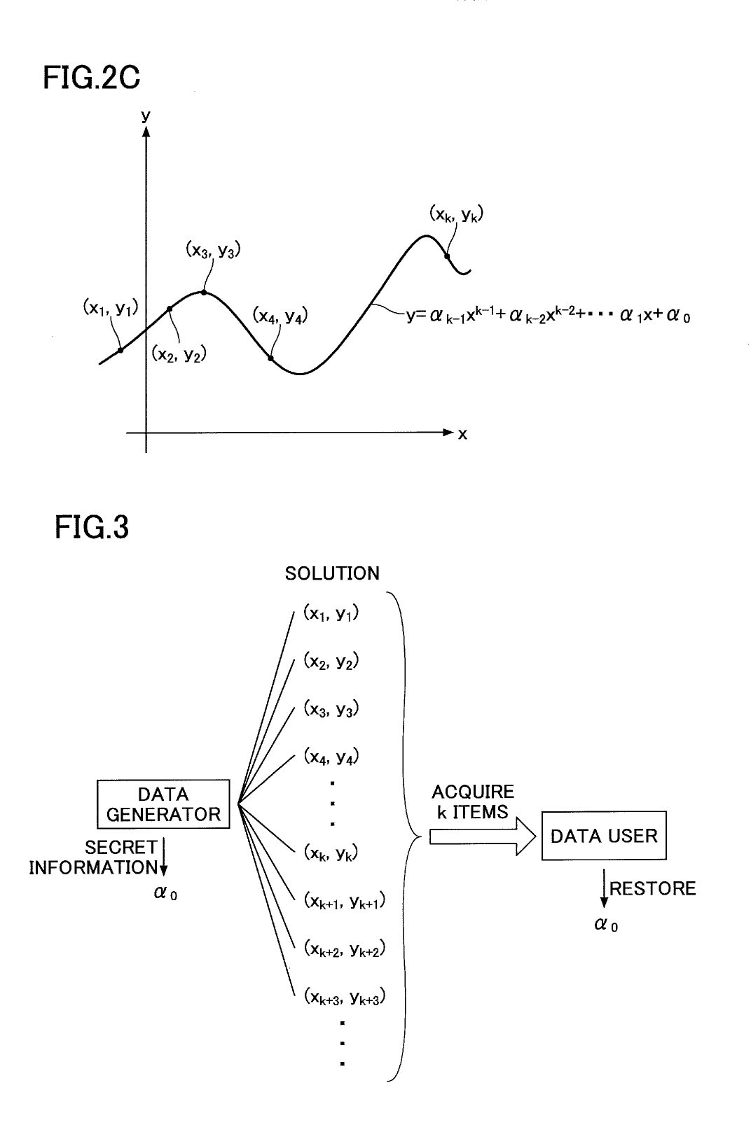

Next, a secret distributed protocol used for generating secret distributed data having high resistance to data loss in signature verification, will be briefly described with reference to FIGS. 2A to 4. FIGS. 2A to 4 are first to third diagrams for describing the secret distributed protocol.

### (1) Overview

In general, a (k−1)th degree polynomial can be uniquely defined if there are a k number of independent solutions. With a (k−1) number of solutions or less, the (k−1)th degree polynomial cannot be uniquely defined. FIG. 2A illustrates a state in which a linear polynomial (y=α₁x+α₀) is uniquely defined based on two independent solutions ((x₁,y₁), (x₂, y₂)).

Furthermore, FIG. 2B illustrates that a quadratic polynomial (y=α₂x²+α₁x+α₀) is uniquely defined based on three independent solutions ((x₁,y₁), (x₂, y₂), (x₃, y₃)). Furthermore, FIG. 2C illustrates that a (k−1)th degree polynomial (y=αₖ₋₁x^{k-1}+αₖ₋₂x^{k-2}+ . . . α₁x+α₀) is uniquely defined based on a k number of independent solutions ((x₁,y₁) (x₂,y₂), . . . (xₖ,yₖ)).

The secret distributed protocol uses such a relationship between a polynomial and the solution of the polynomial. As illustrated in FIG. 3, when a secret distributed protocol is used, a data generator, which generates secret information, embeds the generated secret information in the zero-degree term (α₀) of the (k−1)th degree polynomial, and generates a plurality of solutions of (k−1)th degree polynomial, and holds the respective solutions separately. Accordingly, even if some solutions among the plurality of solutions are leaked out, the secret information (α₀) is not restored. That is, the secret distributed protocol has a characteristic of being highly resistant to leakage.

In addition, as illustrated in FIG. 3, according to the secret distributed protocol, the data user can restore the secret information (α₀) by acquiring a k number of solutions among a plurality of solutions from the data generator. This is because it is possible to uniquely define the (k−1)th degree polynomial by using a k number of solutions. That is, the secret distributed protocol also has a characteristic of being highly resistant to data loss.

In the first embodiment, the secret distributed protocol is applied to the time series data, by focusing on the characteristic that the resistance to data loss is high, among the above characteristics.

### (2) Application of Secret Distributed Protocol to Time Series Data

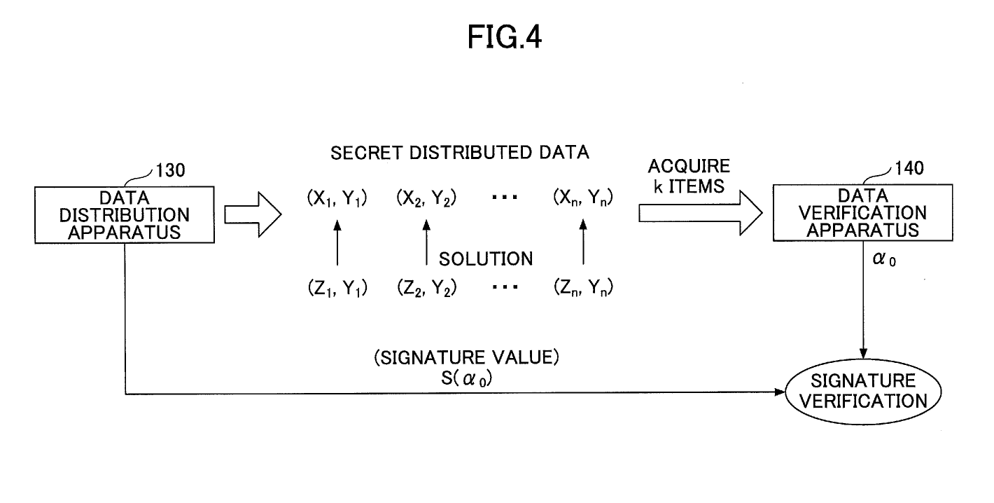

The data distribution apparatus 130 according to the first embodiment generates fusion data based on the time series data in a predetermined section and the corresponding time series data, and applies the secret distributed protocol to the generated fusion data, thereby achieving an improvement in the resistance to data loss in signature verification. This will be specifically described with reference to FIG. 4.

In the data distribution apparatus 130, first, an n number (n is an integer that is greater than or equal to 2) of fusion data items are generated, based on imaging data that is time series data in a predetermined section and voice data that is time series data in a corresponding section. Note that in the following description, among the n number of fusion data items, the i-th fusion data is expressed as “Xᵢ”. Furthermore, “Zᵢ” is the summed value (fusion data summed value) of the respective data items included in the fusion data (Xᵢ).

Subsequently, the data distribution apparatus 130 generates an n number of solutions of the (k−1)th degree polynomial based on the n number of fusion data summed values (Zᵢ). At this time, a random value is used for the k number (k is an integer that is greater than or equal to 1 but less than n) of parameters (αₖ₋₁, αₖ₋₂, . . . α₀) of the (k−1)th degree polynomial. Note that in the present embodiment, the i-th value among an n number of variables y calculated by assigning an n number of fusion data summed values (Zᵢ) to a variable x, is expressed as parameter information “Yᵢ”. Yᵢ can be calculated based on the following formula.

Yᵢ=Σ(t=0˜k−1)αt×Zᵢ [Formula 1]

As a result, the data distribution apparatus 130 can calculate an n number of solutions (Zᵢ, Yᵢ) of the (k−1)th degree polynomial (y=αₖ₋₁x^{k-1}+αₖ₋₂x^{k-2}+ . . . α₁x+α₀), from the n number of fusion data summed values (Zᵢ). The data distribution apparatus 130 distributes, to the data verification apparatus 140 as secret distributed data, sets of an n number of fusion data items (Xᵢ) and parameter information items (Yᵢ) corresponding to the calculated n number of solutions (Zᵢ, Yᵢ).

Even when some of the n number of secret distributed data items (Xᵢ, Yᵢ) are lost, if a k number of secret distributed data items (Xᵢ, Yᵢ) are accumulated, the data verification apparatus 140 can derive a k number of solutions (Zᵢ, Yᵢ). Accordingly, the data verification apparatus 140 can calculate the parameters (αₖ₋₁, αₖ₋₂ . . . α₀) based on a k number of solutions (Zᵢ, Yᵢ).

Here, it is assumed that a k number of secret distributed data items (Xᵢ, Yᵢ) have not been falsified. In this case, the following two parameters should match.
Parameters (αₖ₋₁, αₖ₋₂, . . . α₀) calculated based on a k number of secret distributed data items (Xᵢ, Yᵢ) by the data verification apparatus 140.
Parameters (αₖ₋₁, αₖ₋₂, . . . α₀) of the (k−1)th degree polynomial used by the data distribution apparatus 130 to generate the n number of solutions (Zᵢ, Yᵢ).

On the other hand, when a k number of secret distributed data items have been falsified, these parameters will not match. That is, by determining whether these parameters match, signature verification can be performed, and when these parameters match (when the signature verification is successful), it is possible to assure the authenticity of the secret distributed data (that the secret distributed data is not falsified).

Note that in the present embodiment, the data verification apparatus 140 determines that the signature verification of the secret distributed data (Xᵢ, Yᵢ) is successful, when one of the parameters (α₀) matches. That is, in the present embodiment, the parameter (α₀) becomes the secret information (the secret information can be defined as information that can be calculated by accumulating a k number of secret distributed data items). Note that in order to determine whether the signature verification is successful by the data verification apparatus 140, the data distribution apparatus 130 calculates a signature value (S) by adding a signature to the secret information (α₀) by using a Sign algorithm as indicated in the following formula, and distributes the signature value (S) to the data verification apparatus 140.

S=Sign(α₀,skₘₒᵥ) [Formula 2]

Note that in formula 2, skₘₒᵥ indicates a signature key generated by the data distribution apparatus 130.

Upon receiving the signature value (S), the data verification apparatus 140 calculates the secret information (α₀) based on the verification key, by using a Vrfy algorithm corresponding to the Sign algorithm. Furthermore, the data verification apparatus 140 determines whether the secret information (α₀) calculated from the k number of secret distributed data items (Xᵢ, Yᵢ) and the secret information (α₀) calculated from the signature value (S) match each other. When these secret information items match each other, the data verification apparatus 140 determines that the signature verification is successful. Conversely, when these secret information items do not match each other, the data verification apparatus 140 determines that the signature verification is unsuccessful.

Note that in the following description, it is assumed that the signature value (S) distributed from the data distribution apparatus 130 is associated with the n number of secret distributed data items (Xᵢ,Yᵢ).

### 3. Hardware Configuration of Data Distribution System—First Embodiment

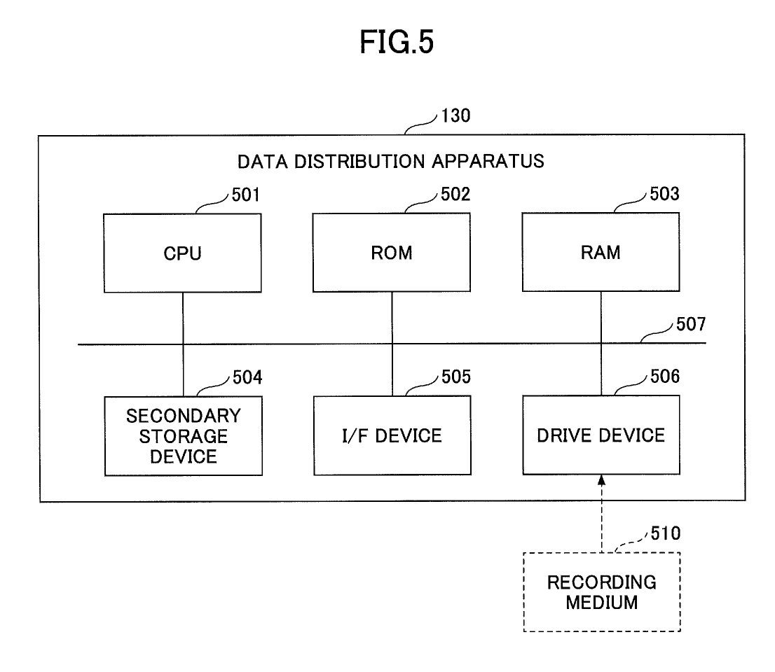

Described next are the hardware configurations of the data distribution apparatus 130 and the data verification apparatus 140 included in the data distribution system 100. Note that the hardware configuration of the data distribution apparatus 130 and the hardware configuration of the data verification apparatus 140 are basically the same, and therefore the hardware configuration of the data distribution apparatus 130 will be described here. FIG. 5 is an example of a hardware block diagram of the data distribution apparatus 130.

As illustrated in FIG. 5, the data distribution apparatus 130 includes a Central Processing Unit (CPU) 501, a Read-Only Memory (ROM) 502, and a Random Access Memory (RAM) 503. Note that the CPU 501, the ROM 502, and the RAM 503 form a so-called computer. The data distribution apparatus 130 further includes a secondary storage device 504, an interface (I/F) device 505, and a drive device 506. Note that the hardware elements included in the data distribution apparatus 130 are connected to each other via a bus 507.

The CPU 501 executes various programs (for example, a data distribution program, etc.) installed in the secondary storage device 504.

The ROM 502 is a nonvolatile memory, and the ROM 502 functions as a main storage device for storing various programs and data, etc., necessary for the CPU 501 to execute various programs installed in the secondary storage device 504. Specifically, the ROM 502 stores a boot program such as Basic Input/Output System (BIOS) and Extensible Firmware Interface (EFI).

The RAM 503 is a volatile memory such as a Dynamic Random Access Memory (DRAM), and a Static Random Access Memory (SRAM), etc. The RAM 503 functions as a main storage device that provides a work area that is expanded when various programs installed in the secondary storage device 504 are executed by the CPU 501.

The secondary storage device 504 stores various installed programs and data used when executing various programs, etc.

The I/F device 505 is a connection device for the data distribution apparatus 130 to connect to the imaging device 110 and the voice input device 120 and to connect to the network 150. The drive device 506 is a device for setting a recording medium 510. The recording medium 510 referred to herein includes a medium that optically, electrically, or magnetically records information, such as a Compact Disk Read-Only Memory (CD-ROM), a flexible disk, and a magneto-optical disk, etc. Alternatively, the recording medium 510 may include a semiconductor memory, etc., for electrically recording information, such as a ROM or a flash memory, etc.

Note that various programs stored in the secondary storage device 504 are installed, for example, by setting the distributed recording medium 510 in the drive device 506, and by reading various programs recorded in the recording medium 510 by the drive device 506. Alternatively, various programs stored in the secondary storage device 504 may be installed by being downloaded from the network via the I/F device 505.

### 4. Functional Configuration of Data Distributing Unit—First Embodiment

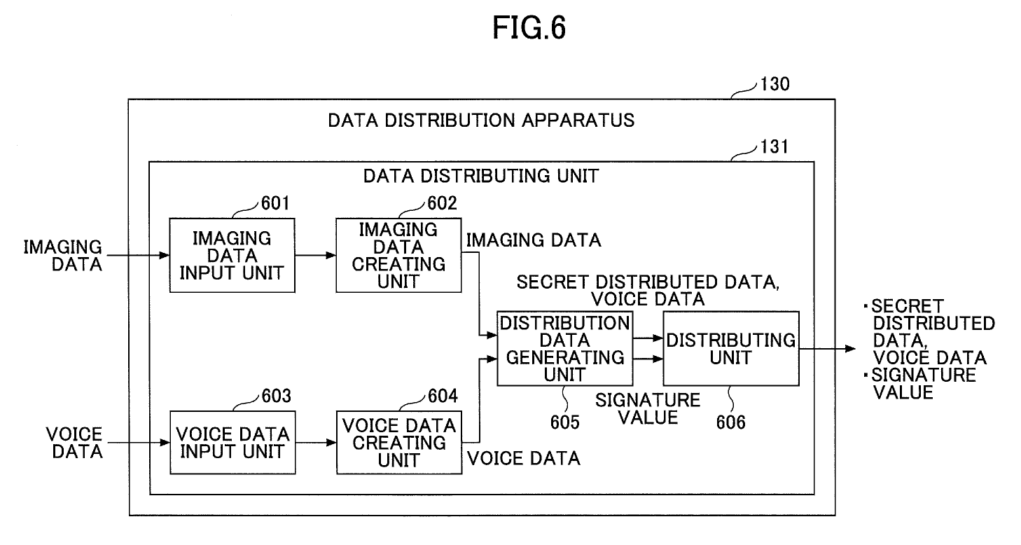

Next, a detailed functional configuration of the data distributing unit 131 implemented in the data distribution apparatus 130 will be described. FIG. 6 is an example of a functional block diagram of the data distributing unit 131.

As illustrated in FIG. 6, the data distributing unit 131 includes an imaging data input unit 601, an imaging data creating unit 602, a voice data input unit 603, a voice data creating unit 604, a distribution data generating unit 605, and a distributing unit 606.

The imaging data input unit 601 acquires the imaging data transmitted from the imaging device 110. The imaging data creating unit 602 converts the acquired imaging data into a predetermined format (for example, H.264/MPEG 4 (Moving Picture Experts Group phase 4), etc.).

The voice data input unit 603 acquires voice data transmitted from the voice input device 120. The voice data creating unit 604 converts the acquired voice data into a predetermined format (for example, AAC (Advanced Audio Coding), etc.).

The distribution data generating unit 605 generates the fusion data (Xᵢ) based on imaging data in a predetermined section and the voice data in a corresponding section, and calculates the parameter information (Yᵢ) based on the generated fusion data (Xᵢ). Furthermore, the distribution data generating unit 605 generates secret distributed data (Xᵢ, Yᵢ) that is a set of fusion data (Xᵢ) and parameter information (Yᵢ), and transmits the secret distributed data (Xᵢ, Yᵢ) together with the voice data of the corresponding section, to the distributing unit 606. Furthermore, the distribution data generating unit 605 calculates the signature value (S) by using the secret information (α₀) that can be calculated by accumulating a k number of secret distributed data items (Xᵢ, Yᵢ), and reports the signature value (S) to the distributing unit 606.

The distributing unit 606 is an example of an outputter. The distributing unit 606 packetizes the secret distributed data and the voice data reported from the distribution data generating unit 605, and distributes the packets by streaming to the data verification apparatus 140 via the network 150. Furthermore, the distributing unit 606 distributes the signature value reported from the distribution data generating unit 605, to the data verification apparatus 140 via the network 150.

Note that the packet format used when packetizing secret distributed data and voice data is determined by the transmission format, and when the transmission format is the network interface format, the packet format is the Real Time Streaming Protocol (RTSP) format or the User Datagram Protocol (UDP) format. Furthermore, when the transmission format is a Universal Serial Bus (USB) interface format, the packet format is the isochronous format.

### 5. Functional Configuration of Distribution Data Generating Unit—First Embodiment

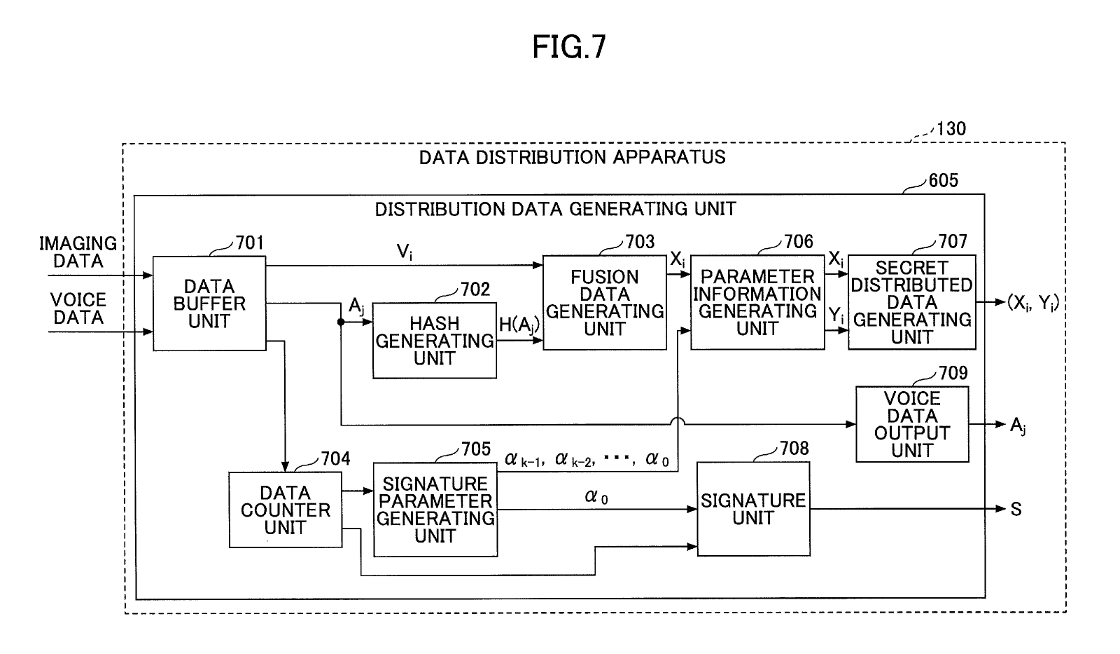

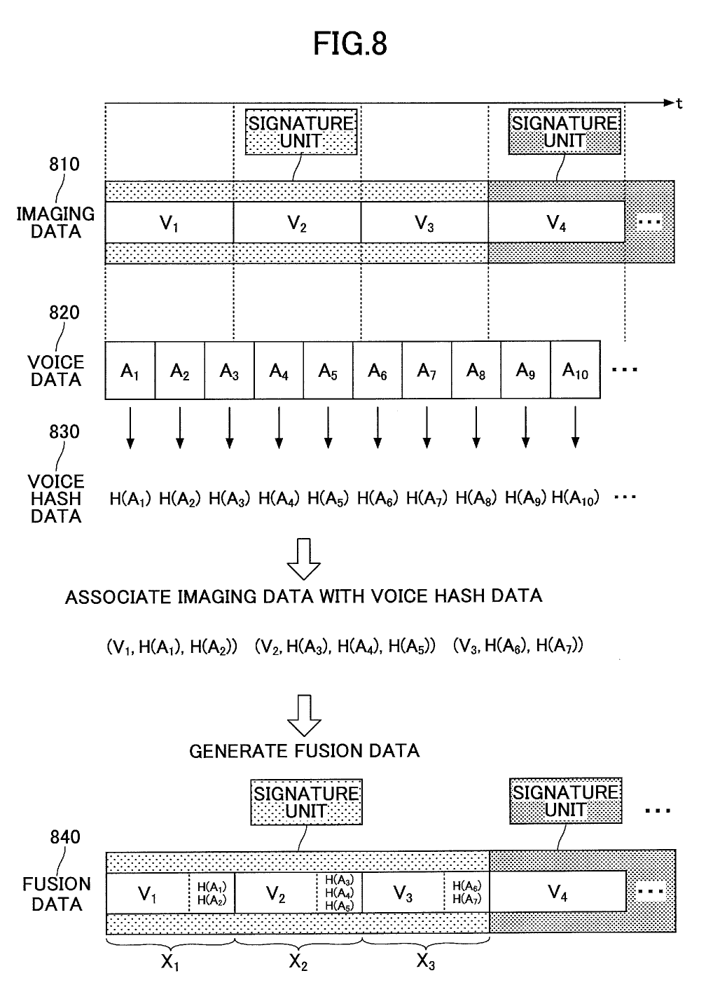

Next, the detailed functional configuration of the distribution data generating unit 605 will be described by using FIG. 7, with reference to FIGS. 8 to 10. FIG. 7 is an example of a functional block diagram of the distribution data generating unit 605.

As illustrated in FIG. 7, the distribution data generating unit 605 includes a data buffer unit 701, a hash generating unit 702, a fusion data generating unit 703, a data counter unit 704, and a signature parameter generating unit 705. Furthermore, the distribution data generating unit 605 includes a parameter information generating unit 706, a secret distributed data generating unit 707, a signature unit 708, and a voice data output unit 709.

The data buffer unit 701 stores imaging data reported from the imaging data creating unit 602 and voice data reported from the voice data creating unit 604 in association with each other.

The hash generating unit 702 reads an m number of voice data items in a section corresponding to imaging data (i-th imaging data) in a predetermined section, from the voice data stored in the data buffer unit 701. Note that among the m number of voice data items, the j-th voice data is set as (Aⱼ).

The hash generating unit 702 generates voice hash data (H (Aⱼ)) by hashing the j-th voice data (Aⱼ). Furthermore, the hash generating unit 702 reports, to the fusion data generating unit 703, the generated m number of voice hash data (H(Aⱼ)).

The fusion data generating unit 703 is an example of a generator. The fusion data generating unit 703 reads the i-th imaging data (Vᵢ) stored in the data buffer unit 701, and acquires an m number of voice hash data items (H(Aⱼ)) from the hash generating unit 702. Furthermore, the fusion data generating unit 703 generates fusion data (Xᵢ) by incorporating the m number of voice hash data items (H(Aⱼ)) into a predetermined area (for example, a metadata area) in the imaging data (Vᵢ). Furthermore, the fusion data generating unit 703 reports the generated fusion data (Xᵢ) to the parameter information generating unit 706.

Here, the flow of the above process until generating the fusion data (Xᵢ) will be described in more detail with reference to FIG. 8. FIG. 8 is a diagram illustrating a method of generating fusion data. As illustrated in FIG. 8, imaging data 810 stored in the data buffer unit 701 is time series data, and the fusion data generating unit 703 reads the imaging data 810 in each of the predetermined sections as imaging data V₁, V₂, V₃, V₄ . . . .

Similarly, voice data 820 stored in the data buffer unit 701 is time series data, and the hash generating unit 702 reads the voice data 820 in each of the predetermined sections as voice data A₁ to A₁₀ . . . . Note that in FIG. 8, in the imaging data 810 and the voice data 820, the imaging data in the predetermined section and the voice data in the predetermined section arranged in the same time zone with respect to a time axis t are associated with each other.

In the example of FIG. 8, the imaging data V₁ in a predetermined section and the voice data A₁ and A₂ in the predetermined section are associated with each other. Similarly, the imaging data V₂ in a predetermined section and the voice data A₃, A₄, and A₅ in the predetermined section are associated with each other. Furthermore, the imaging data V₃ in a predetermined section and the voice data A₆ and A₇ in the predetermined section are associated with each other.

Voice hash data 830 (H(A₁) to H(A₁₀)) is calculated by hashing each voice data 820 (A₁ to A₁₀) by the hash generating unit 702. Among the calculated voice hash data 830 (H (A₁) to H(A₁₀)), the voice hash data items H(A₁) and H(A₂) are associated with the imaging data V₁ in a predetermined section. Furthermore, the voice hash data items H(A₃) to H(A₅) are associated with the imaging data V₂ in a predetermined section. Furthermore, the voice hash data items H(A₆) and H(A₇) are associated with the imaging data V₃ in a predetermined section. The fusion data generating unit 703 generates fusion data 840 by incorporating the voice hash data 830 (H(A₁) to H(A₇)) into the imaging data V₁ to V₃ in predetermined sections.

In the example of FIG. 8, it is indicated that the fusion data (X₁) has been generated by incorporating the voice hash data H(A₁) and H(A₂) in the metadata area of the imaging data V₁ in a predetermined section. Similarly, in the example of FIG. 8, it is indicated that the fusion data (X₂) has been generated by incorporating the voice hash data H(A₃), H(A₄), and H(A₅) in the metadata area of the imaging data V₂ in a predetermined section. Similarly, in the example of FIG. 8, it is indicated that the fusion data (X₃) has been generated by incorporating the voice hash data H(A₆) and H(A₇) in the metadata area of the imaging data V₃ in a predetermined section.

Note that in FIG. 8, a “signature unit” refers to an assembly of imaging data items in predetermined sections for calculating the signature value (α₀). In the example of FIG. 8, the signature unit is formed by imaging data items in three predetermined sections, and therefore the signature unit (n)=3.

Referring back to FIG. 7, the data counter unit 704 counts the number of imaging data items in predetermined sections stored in the data buffer unit 701. When the count value reaches the signature unit (n), the data counter unit 704 reports this to the signature parameter generating unit 705 and the signature unit 708. As described above, the signature unit (n)=3, and therefore when imaging data items V₁ to V₃ in predetermined sections are stored in the data buffer unit 701, the data counter unit 704 sends a report indicating that the count value has reached the signature unit (n), to the signature parameter generating unit 705 and the signature unit 708.

The signature parameter generating unit 705 includes a random value generator, and upon receiving a report from the data counter unit 704 that the count value has reached the signature unit (n), the signature parameter generating unit 705 acquires a k number of random values generated by the random value generator, as parameters (αₖ₋₁, αₖ₋₂, . . . α₀). Furthermore, the signature parameter generating unit 705 reports the acquired parameters (αₖ₋₁, αₓ₋₂ . . . α₀) to the parameter information generating unit 706. Furthermore, the signature parameter generating unit 705 reports the parameter (α₀) as secret information to the signature unit 708.

The parameter information generating unit 706 is an example of a calculator. The parameter information generating unit 706 acquires the fusion data (Xᵢ) corresponding to the signature unit (n) generated by the fusion data generating unit 703, and the parameters (αₖ₋₁, αₖ₋₂, . . . α₀) acquired by the signature parameter generating unit 705. Furthermore, the parameter information generating unit 706 calculates the fusion data summed value (Zᵢ) corresponding to the signature unit (n), from the acquired fusion data (Xᵢ) corresponding to the signature unit (n). Furthermore, the parameter information generating unit 706 calculates, by using formula 1, the parameter information (Yᵢ) corresponding to the signature unit (n), based on the fusion data summed value (Zᵢ) corresponding to the signature unit (n) and the parameters (αₖ₋₁, αₖ₋₂, . . . α₀).

The secret distributed data generating unit 707 generates secret distributed data (Xᵢ, Yᵢ) corresponding to the signature unit (n) by associating the fusion data (Xᵢ) with the parameter information (Yᵢ), and outputs the secret distributed data (Xᵢ, Yᵢ).

The voice data output unit 709 reads and outputs an m number of voice data items (Aⱼ) in a section corresponding to the imaging data (Vᵢ) in a predetermined section, from the data buffer unit 701.

The signature unit 708 is an example of a signature means. The signature unit 708 receives a report from the data counter unit 704 that the count value has reached the signature unit (n), and then the signature unit 708 uses the secret information (α₀) output from the signature parameter generating unit 705 to calculate a signature value (S). Note that in the present embodiment, the signature value (S) is calculated by using the Sign algorithm; however, the signature algorithm used for calculating the signature value (S) is not limited to the Sign algorithm. For example, the RSA algorithm, the RSASSA-PSS algorithm, or the ElGamal algorithm may be used.

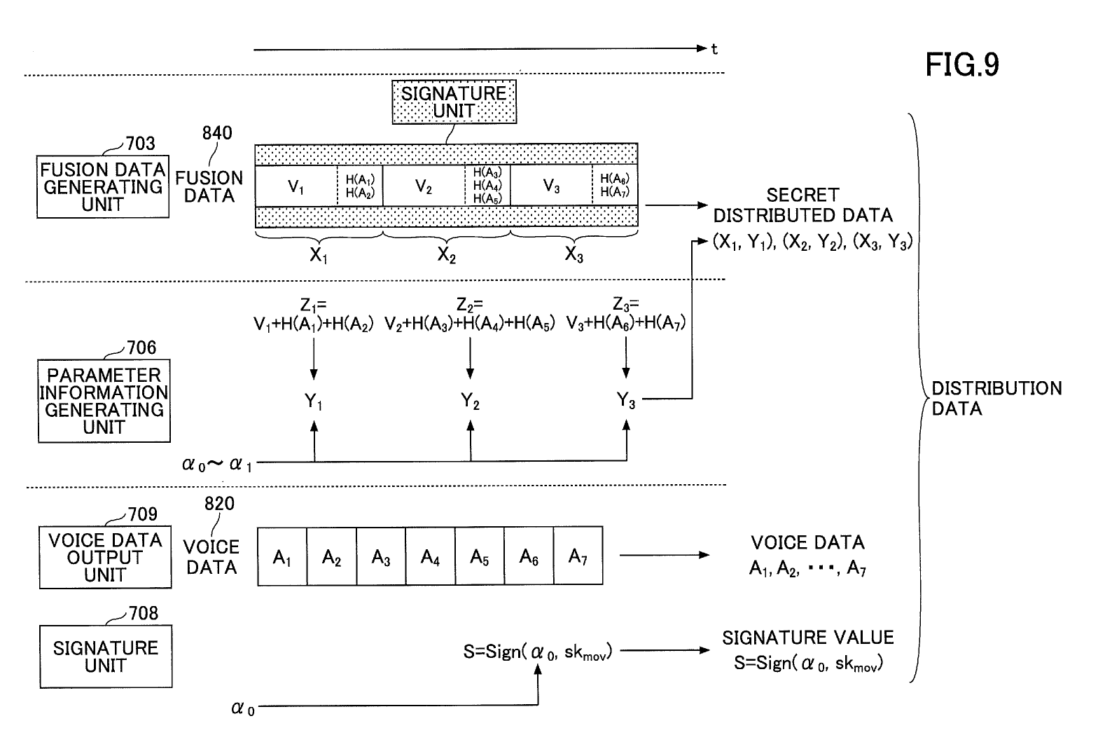

Here, the flow of the above process until the secret distributed data (Xᵢ, Yᵢ), the voice data (Aⱼ), and the signature value (S) are output (that is, the flow of the process until distribution data is output) will be described in more detail with reference to FIG. 9. FIG. 9 is a diagram illustrating a method of generating distribution data.

As illustrated in FIG. 9, it is assumed that the fusion data (X₁) is generated by the fusion data generating unit 703. In this case, the parameter information generating unit 706 calculates a summed value (fusion data summed value (Z₁)) obtained by adding the imaging data (V₁) in a predetermined section included in the fusion data (X₁) and the voice hash data (H(A₁), H(A₂)) in a corresponding section. Furthermore, parameter information generating unit 706 generates parameter information (Y₁), based on the calculated summed value (fusion data summed value (Z₁)) and the parameters (α₀, α₁).

Similarly, it is assumed that the fusion data (X₂) is generated by the fusion data generating unit 703. In this case, the parameter information generating unit 706 calculates a summed value (fusion data summed value (Z₂)) obtained by adding the imaging data (V₂) in a predetermined section included in the fusion data (X₂) and the voice hash data (H(A₃), H(A₄), H(A₅)) in a corresponding section. Furthermore, parameter information generating unit 706 generates parameter information (Y₂), based on the calculated summed value (fusion data summed value (Z₂)) and the parameters (α₀, α₁).

Similarly, it is assumed that the fusion data (X₃) is generated by the fusion data generating unit 703. In this case, the parameter information generating unit 706 calculates a summed value (fusion data summed value (Z₃)) obtained by adding the imaging data (V₃) in a predetermined section included in the fusion data (X₃) and the voice hash data (H(A₆). H(A₇)) in a corresponding section. Furthermore, parameter information generating unit 706 generates parameter information (Y₃), based on the calculated summed value (fusion data summed value (Z₃)) and the parameters (α₀, α₁).

Accordingly, the secret distributed data generating unit 707 can output (X₁, Y₁) (X₂, Y₂) (X₃, Y₃) as secret distributed data.

On the other hand, the voice data output unit 709 outputs voice data (A₁, A₂, A₃, . . . A₇) in predetermined sections stored in the data buffer unit 701. Furthermore, the signature unit 708 calculates the signature value (S) by using the secret information (α₀), and outputs the signature value (S).

As a result, secret distributed data (X₁, Y₁) (X₂, Y₂), (X₃, Y₃), voice data (A₁, A₂, A₃, . . . A₇), and the signature value (S) are output as distribution data corresponding to the signature unit (n), from the distribution data generating unit 605.

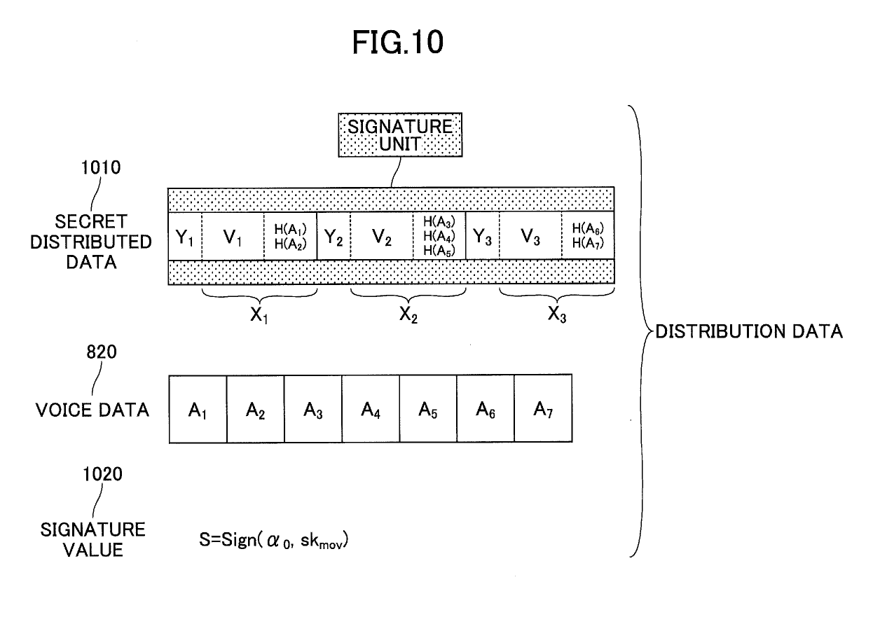

FIG. 10 is a diagram illustrating an example of the distribution data output from the distribution data generating unit. As illustrated in secret distributed data 1010 of FIG. 10, the parameter information (Y₁) is incorporated in the metadata area in the imaging data (V₁) in a predetermined section and output. Similarly, the parameter information (Y₂) is incorporated in the metadata area in the imaging data (V₂) in a predetermined section and output, and the parameter information (Y₃) is incorporated in the metadata area in the imaging data (V₃) in a predetermined section and output.

Furthermore, the voice data (A₁, A₂, A₃, . . . A₇) in predetermined sections in the voice data 820 is output in association with the respective imaging data items (V₁, V₂, V₃) in predetermined sections included in the secret distributed data 1010.

Furthermore, a signature value 1020 is output in association with the secret distributed data 1010 corresponding to the signature unit (n).

### 6. Process by Data Distributing Unit—First Embodiment

Next, the flow of each process (imaging data acquisition process, voice data acquisition process, and distribution process) executed by the data distributing unit 131 will be described.

### (1) Imaging Data Acquisition Process and Voice Data Acquisition Process

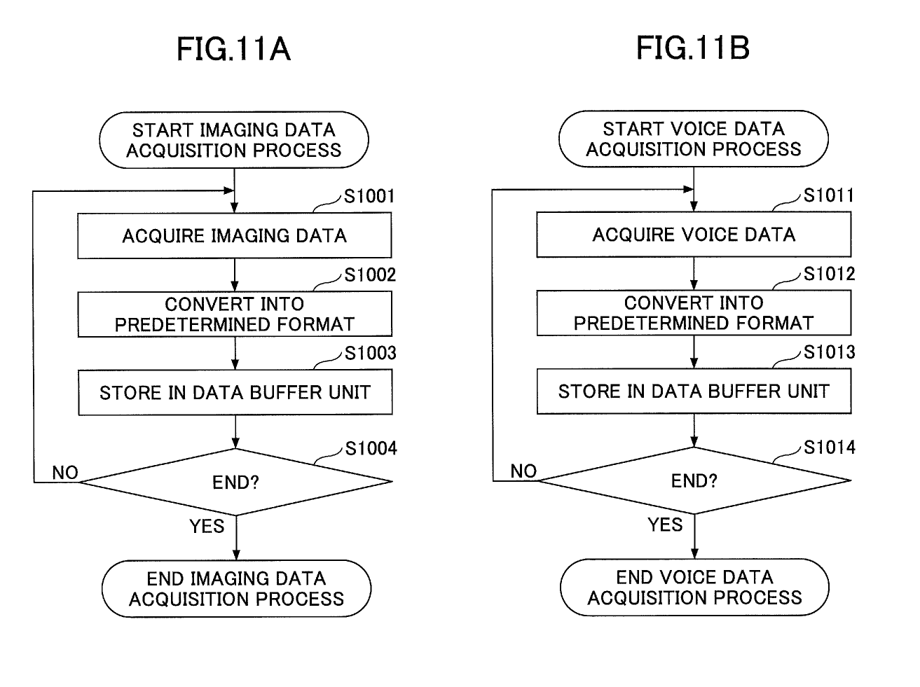

First, a description is given of the flows of an imaging data acquisition process and a voice data acquisition process. FIGS. 11A and 11B are flowcharts respectively illustrating the flows of an imaging data acquisition process and a voice data acquisition process.

The imaging data acquisition process illustrated in FIG. 11A is executed by the data distributing unit 131 when the data distribution system 100 is activated. In step S1001, the imaging data input unit 601 acquires imaging data transmitted from the imaging device 110.

In step S1002, the imaging data creating unit 602 converts the acquired imaging data into a predetermined format. In step S1003, the imaging data creating unit 602 stores the imaging data converted into the predetermined format, in the data buffer unit 701.

In step S1004, the imaging data input unit 601 determines whether to continue the acquisition of imaging data. When the acquisition of imaging data is to be continued (NO in step S1004), the process returns to step S1001. Conversely, when the acquisition of imaging data is to be terminated (YES in step S1004), the imaging data acquisition process is terminated.

Similarly, the voice data acquisition process illustrated in FIG. 11B is executed by the data distributing unit 131 when the data distribution system 100 is activated. In step S1011, the voice data input unit 603 acquires voice data transmitted from the voice input device 120.

In step S1012, the voice data creating unit 604 converts the acquired voice data into a predetermined format. In step S1013, the voice data creating unit 604 stores the voice data converted into a predetermined format in the data buffer unit 701, in association with the imaging data.

In step S1014, the voice data input unit 603 determines whether to continue the acquisition of the voice data. When the acquisition of the voice data is to be continued (NO in step S1014), the process returns to step S1011. Conversely, when the acquisition of the voice data is to be terminated (YES in step S1014), the voice data acquisition process is terminated.

### (2) Distribution Process

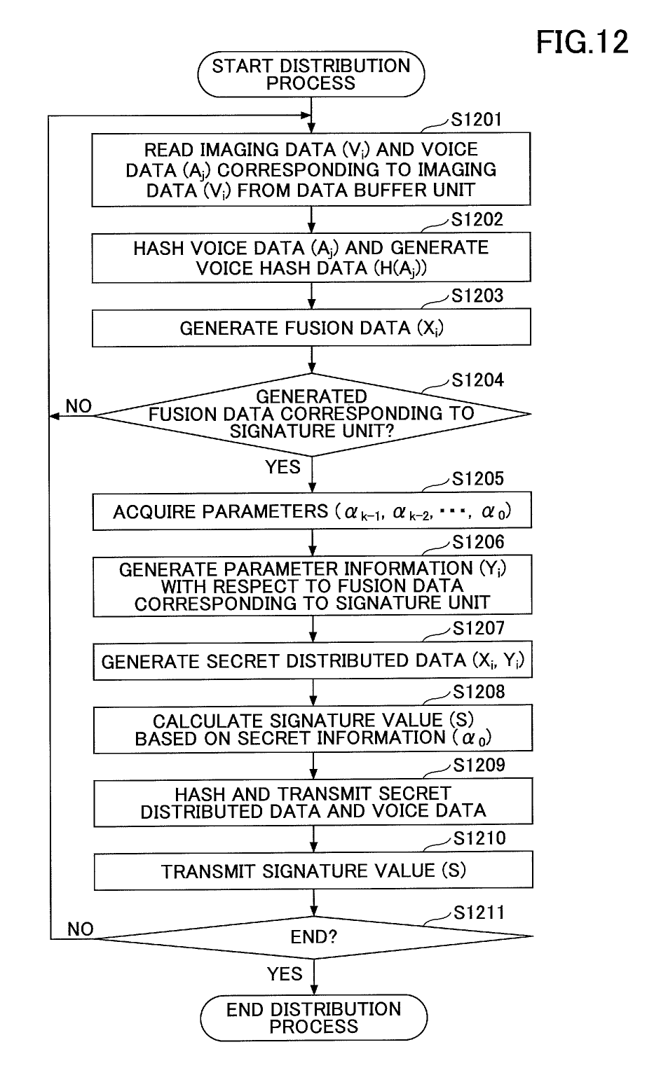

Next, the flow of the distribution process is described. FIG. 12 is a flowchart illustrating the flow of the distribution process. The data distributing unit 131 executes the distribution process illustrated in FIG. 12, when the data distribution system 100 is activated.

In step S1201, the fusion data generating unit 703 reads the imaging data (Vᵢ) in a predetermined section from the data buffer unit 701. Furthermore, the hash generating unit 702 reads an m number of voice data items (Aⱼ) in a section corresponding to the imaging data (Vᵢ) in the predetermined section, from the data buffer unit 701.

In step S1202, the hash generating unit 702 hashes the m number of voice data items (Aⱼ) that have been read, to generate an m number of voice hash data items (H(Aⱼ)).

In step S1203, the fusion data generating unit 703 incorporates the m number of voice hash data items (H(Aⱼ)) into the imaging data (Vᵢ) in the predetermined section read out from the data buffer unit 701, to generate the fusion data (Xᵢ).

In step S1204, the data counter unit 704 determines whether the fusion data generating unit 703 has generated a number of fusion data items corresponding to the signature unit (n). In step S1204, when it is determined that fusion data corresponding to the signature unit (n) has not been generated (NO in step S1204), the process returns to step S1201.

Conversely, in step S1204, when it is determined that fusion data corresponding to the signature unit (n) has been generated (NO in step S1204), the process proceeds to step S1205. In step S1205, the signature parameter generating unit 705 acquires a k number of random values generated by the random value generator, as parameters (αₖ₋₁, αₖ₋₂ . . . α₀).

In step S1206, the parameter information generating unit 706 acquires the fusion data (Xᵢ) corresponding to the signature unit (n) and the k number of parameters (αₖ₋₁, αₖ₋₂ . . . α₀). Furthermore, the parameter information generating unit 706 calculates a fusion data summed value (Zᵢ) corresponding to the signature unit (n) from the acquired fusion data (Xᵢ) corresponding to the signature unit (n). Furthermore, the parameter information generating unit 706 calculates parameter information (Yᵢ) corresponding to the signature unit (n), by using the calculated fusion data summed value (Zᵢ) corresponding to the signature unit (n) and the k number of parameters.

In step S1207, the secret distributed data generating unit 707 generates secret distributed data (Xᵢ, Yᵢ) that is a set of the fusion data (Xᵢ) and the parameter information (Yᵢ).

In step S1208, the signature unit 708 acquires the parameter (α₀) acquired by the signature parameter generating unit 705, as secret information, and adds a signature to the acquired secret information (α₀). Accordingly, the signature unit 708 calculates a signature value (S) based on the acquired secret information (α₀).

In step S1209, the distributing unit 606 packetizes the secret distributed data (Xᵢ, Yᵢ) generated by the secret distributed data generating unit 707 and the voice data (Aⱼ), and distributes the packets by streaming.

In step S1210, the distributing unit 606 distributes the signature value (S) calculated by the signature unit 708.

In step S1211, the distribution data generating unit 605 determines whether to continue the distribution process. In step S1211, when it is determined that the distribution process is to be continued (NO in step S1211), the process returns to step S1201. Conversely, in step S1211, when it is determined that the distribution process is to be terminated (YES in step S1211), the distribution process is terminated.

### 7. Functional Configuration of Data Verifying Unit—First Embodiment

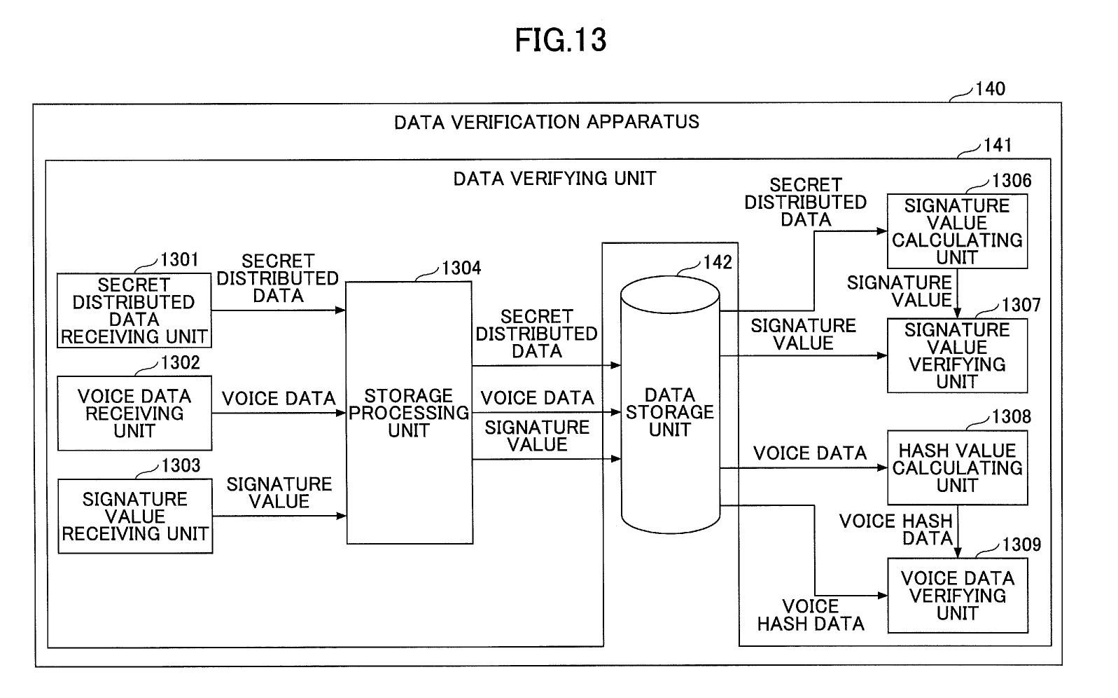

Next, a detailed functional configuration of the data verifying unit 141 implemented in the data verification apparatus 140 will be described. FIG. 13 is an example of a functional block diagram of the data verifying unit 141.

As illustrated in FIG. 13, the data verifying unit 141 includes a secret distributed data receiving unit 1301, a voice data receiving unit 1302, a signature value receiving unit 1303, and a storage processing unit 1304. Furthermore, the data verifying unit 141 includes a signature value calculating unit 1306, a signature value verifying unit 1307, a hash value calculating unit 1308, and a voice data verifying unit 1309.

The secret distributed data receiving unit 1301 receives secret distributed data (a set of fusion data (Xᵢ) and parameter information (Yᵢ)) corresponding to the signature unit (n) that has been distributed by streaming from the data distribution apparatus 130.

The voice data receiving unit 1302 receives the voice data (Aⱼ) corresponding to the secret distributed data distributed by streaming from the data distribution apparatus 130.

The signature value receiving unit 1303 receives the signature value (S) corresponding to the secret distributed data distributed from the data distribution apparatus 130.

The storage processing unit 1304 stores, in association with each other in the data storage unit 142, the secret distributed data received by the secret distributed data receiving unit 1301, the voice data received by the voice data receiving unit 1302, and the signature value received by the signature value receiving unit 1303.

The signature value calculating unit 1306 determines whether the number of secret distributed data items that have been stored in the data storage unit 142 is k or more, to determine whether the signature verification is successful, and when the signature value calculating unit 1306 determines that the number is less than k, the signature value calculating unit 1306 determines that the signature verification is unsuccessful.

Furthermore, when it is determined that the number of stored secret distributed data items is k or more, the signature value calculating unit 1306 reads the k number of secret distributed data items from the data storage unit 142. The signature value calculating unit 1306 functions as a secret information calculator, and calculates secret information (α₀) by using the following formula, based on the k number of secret distributed data items (Xᵢ, Yᵢ) that have been read.

α₀=Σ_{(p=1˜k)}YᵢₚΠ_{(0≤q≤k,q≠p)}(Z_{iq})/((Z_{iq})−(Zᵢₚ)) [Formula 3]

Note that in the above formula, Zᵢ is the summed value (fusion data summed value) of the imaging data (V₁) in the predetermined section included in the fusion data (X₁) and the m number of voice hash data items (H(Aⱼ)) in the corresponding section.

The signature value verifying unit 1307 is an example of a first determining unit. The signature value verifying unit 1307 reads the signature value (S) stored in the data storage unit 142 and calculates secret information (α₀) based on a verification key vkₘₒᵥ by using the vrfy algorithm indicated in the following formula.

Vrfy(S,νkₘₒᵥ)=α₀ [Formula 4]

Note that the signature value verifying unit 1307 determines whether the signature verification is successful, by comparing the secret information (α₀) calculated by the signature value calculating unit 1306 with the secret information (α₀) calculated by using the vrfy algorithm based on the signature value (S). As a result of the comparison, when the two match, the signature value verifying unit 1307 determines that the signature verification is successful (the secret distributed data (Xᵢ, Yᵢ) has not been falsified). Conversely, when the two do not match, the signature value verifying unit 1307 determines that the signature verification is unsuccessful (the secret distributed data (Xᵢ, Yᵢ) has been falsified).

The hash value calculating unit 1308 is an example of a hash generating unit. The hash value calculating unit 1308 reads the voice data (Aⱼ) associated with the secret distributed data (Xᵢ, Yᵢ) stored in the data storage unit 142, and hashes the voice data (Aⱼ) to generate an m number of voice hash data items (H(Aⱼ)). The hash value calculating unit 1308 reports the generated m number of voice hash data items (H(Aⱼ)) to the voice data verifying unit 1309.

The voice data verifying unit 1309 is an example of a second determining unit. The voice data verifying unit 1309 reads the m number of voice hash data items (H(Aⱼ)) incorporated in the secret distributed data (Xᵢ, Yᵢ) stored in the data storage unit 142. The voice data verifying unit 1309 compares the m number of voice hash data items (H(Aⱼ)) that have been read with the m number of voice hash data items (H(Aⱼ)) reported from the hash value calculating unit 1308.

Here, it is assumed that the signature value verifying unit 1307 has already determined that the secret distributed data (Xᵢ, Yᵢ) has not been falsified. In this case, when the voice hash data items match, the voice data verifying unit 1309 determines that the m number of voice data items (Aⱼ) stored in the data storage unit 142 have not been falsified. Furthermore, the voice data verifying unit 1309 determines that information, which indicates the association between the imaging data (Vᵢ) in a predetermined section and the m number of voice data items (Aⱼ) in a corresponding section, has not been falsified.

Conversely, when the voice hash data items do not match, the voice data verifying unit 1309 determines that one of the m number of voice data items (Aⱼ) stored in the data storage unit 142 has been falsified. Alternatively, the voice data verifying unit 1309 determines that the information, which indicates the association between the imaging data (Vᵢ) in a predetermine section and an m number of voice data items (Aⱼ) in a corresponding section, has been falsified.

### 8. Process by Data Verifying Unit—First Embodiment

Next, the flows of processes (secret distributed data verification process and voice data verification process) executed by the data verifying unit 141 will be described.

### (1) Secret Distributed Data Verification Process

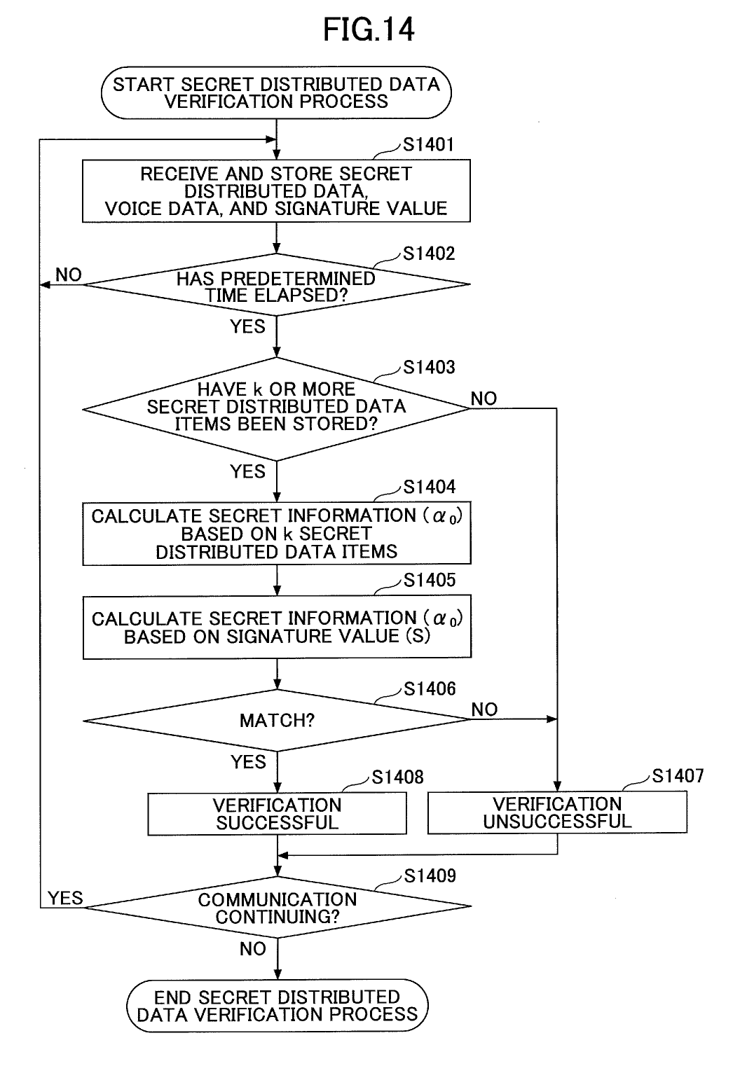

First, a description is given of the flow of a secret distributed data verification process. FIG. 14 is a flowchart illustrating the flow of the secret distributed data verification process. When the data verification apparatus 140 is communicably connected to the data distribution apparatus 130, the flowchart illustrated in FIG. 14 is executed by the data verifying unit 141.

In step S1401, the secret distributed data receiving unit 1301 receives the secret distributed data (Xᵢ, Yᵢ), and the voice data receiving unit 1302 receives the voice data (Aⱼ). Furthermore, the signature value receiving unit 1303 receives the signature value (S). Furthermore, the storage processing unit 1304 stores the received secret distributed data (Xᵢ, Yᵢ), the voice data (Aⱼ), and the signature value (S) in the data storage unit 142 in association with each other.

In step S1402, the storage processing unit 1304 determines whether a predetermined time has elapsed. When it is determined in step S1402 that the predetermined time has not elapsed, the storage processing unit 1304 waits until the predetermined time elapses.

Conversely, when it is determined in step S1402 that the predetermined time has elapsed, the process proceeds to step S1403. In step S1403, the signature value calculating unit 1306 determines whether k or more secret distributed data items (Xᵢ, Yᵢ) have been stored in the data storage unit 142. When it is determined in step S1403 that k or more secret distributed data items (Xᵢ, Yᵢ) have not been stored (NO in step S1403), the process proceeds to step S1407, and the signature value calculating unit 1306 determines that the signature verification is unsuccessful.

Conversely, when it is determined in step S1403 that k or more secret distributed data items (Xᵢ, Yᵢ) have been stored (YES in step S1403), the process proceeds to step S1404. In step S1404, the signature value calculating unit 1306 reads the k number of secret distributed data items (Xᵢ, Yᵢ) from the data storage unit 142, calculates the fusion data summed value (Zᵢ), and calculates the secret information (α₀) by using formula 3.

In step S1405, the signature value verifying unit 1307 reads the signature value (S) stored in the data storage unit 142 and calculates secret information (α₀) based on the verification key (vkₘₒᵥ) by using the vrfy algorithm.

In step S1406, the signature value verifying unit 1307 compares the secret information (α₀) calculated by the signature value calculating unit 1306 with the secret information (α₀) calculated by using the vrfy algorithm based on the signature value (S). As a result of the comparison, if the secret information items do not match, the process proceeds to step S1407, and it is determined that the signature verification is unsuccessful (the secret distributed data (Xᵢ, Yᵢ) has been falsified).

Conversely, as a result of the comparison in step S1406, when the secret information items match, the process proceeds to step S1408, and it is determined that the signature verification is successful (the secret distributed data (Xᵢ, Yᵢ) has not been falsified).

In step S1409, the storage processing unit 1304 determines whether communication with the data distribution apparatus 130 is continuing. When it is determined that the communication is continuing (YES in step S1409), the process returns to step S1401. Conversely, when it is determined that the communication is disconnected (NO in step S1409), the secret distributed data verification process is terminated.

### (2) Voice Data Verification Processing

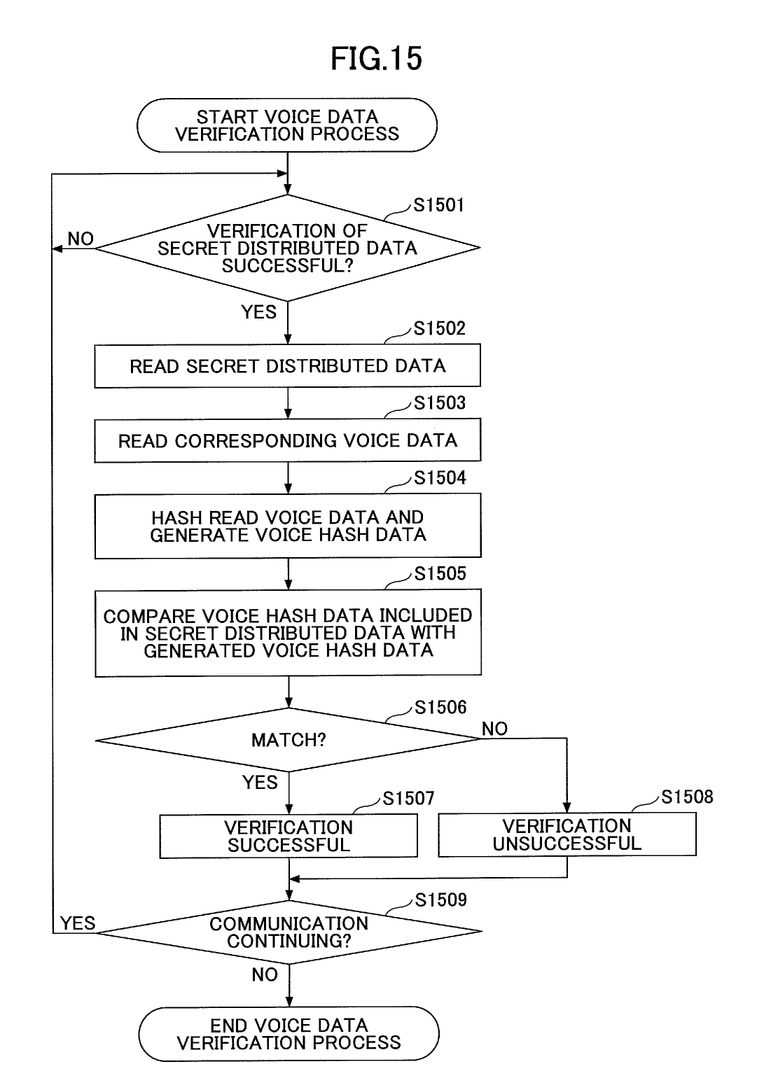

Next, a description is given of the flow of a voice data verification process. FIG. 15 is a flowchart illustrating the flow of the voice data verification process. When the data verification apparatus 140 is communicably connected to the data distribution apparatus 130, the flowchart illustrated in FIG. 15 is executed by the data verifying unit 141.

In step S1501, the hash value calculating unit 1308 determines whether signature verification by the signature value verifying unit 1307 has been successful for the secret distributed data (Xᵢ, Yᵢ) corresponding to the voice data (Aⱼ) in a predetermined section. When it is determined in step S1501 that the signature verification is not successful (NO in step S1501), the voice data in the next predetermined section is processed.

Conversely, when it is determined in step S1501 that the signature verification is successful (YES in step S1501), the process proceeds to step S1502. In step S1502, the voice data verifying unit 1309 reads the secret distributed data (Xᵢ, Yᵢ) for which the signature verification has been determined to be successful, from the data storage unit 142.

In step S1503, the hash value calculating unit 1308 reads, from the data storage unit 142, voice data items (Aⱼ) in an m number of predetermined sections corresponding to the secret distributed data (Xᵢ, Yᵢ) that has been read.

In step S1504, the hash value calculating unit 1308 hashes the voice data items (Aⱼ) in the m number of predetermined sections that have been read, to generate an m number of voice hash data items (H(Aⱼ)).

In step S1505, the voice data verifying unit 1309 compares the m number of voice hash data items (H(Aⱼ)) incorporated in the secret distributed data (Xᵢ, Yᵢ) that has been read with the m number of voice hash data items (H(Aⱼ)) generated in step S1504.

When it is determined in step S1506 that the voice hash data items do not match (NO in step S1506), the process proceeds to step S1508. In step S1508, the voice data verifying unit 1309 determines that the voice data (Aⱼ) in the predetermined section that has been read in step S1503, has been falsified. Alternatively, the voice data verifying unit 1309 determines that the information indicating the association between the voice data (Aⱼ) in the predetermined section that has been read in step S1503 and the imaging data (Vᵢ) in the corresponding section, has been falsified.

Conversely, when it is determined in step S1506 that both voice hash data items match (YES in step S1506), the process proceeds to step S1507. In step S1507, the voice data verifying unit 1309 determines that the voice data items (Aⱼ) in the m number of predetermined sections that have been read in step S1503, have not been falsified. Furthermore, the voice data verifying unit 1309 determines that the information, which indicates the association between the voice data items (Aⱼ) in the m number of predetermined sections that have been read in step S1503 and the imaging data (Vᵢ), has not been falsified.

In step S1509, the storage processing unit 1304 determines whether communication with the data distribution apparatus 130 is continuing. When it is determined that the communication is continuing (YES in step S1509), the process returns to step S1501. Conversely, when it is determined that the communication is disconnected (NO in step S1509), the voice data verification process is terminated.

### 9. Application Example—First Embodiment

Next, as an application example of the data distribution system 100, an example of a case where the secret distributed data or the voice data is lost and an example of a case where the secret distributed data or the voice data is falsified will, be described.

### (1) Example of Loss of Secret Distributed Data or Voice Data

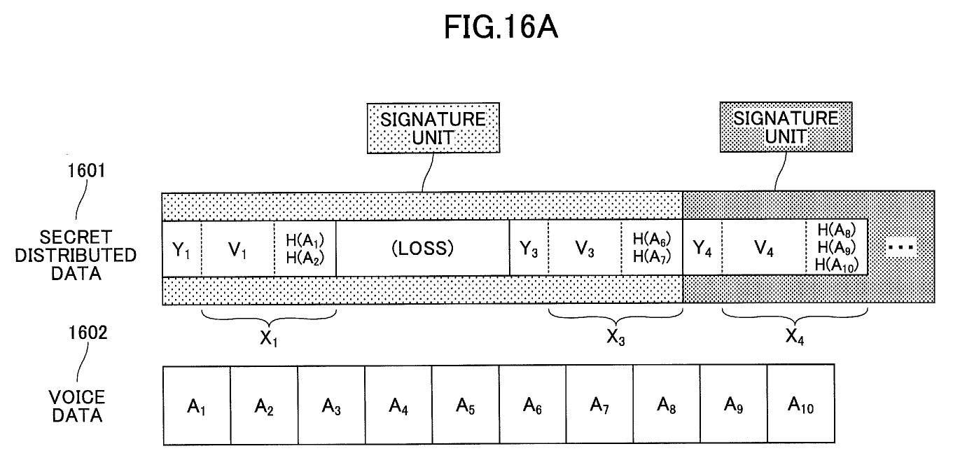

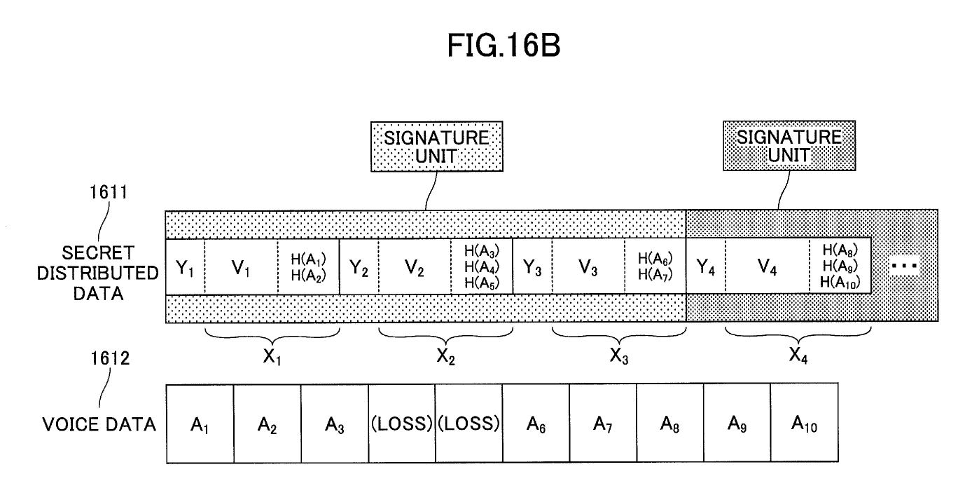

First, examples of the loss of the secret distributed data or voice data will be described. FIGS. 16A and 16B are diagrams illustrating examples of loss of secret distributed data or voice data.

As illustrated in FIG. 16A, among the sets ((X₁,Y₁) to (X₃,Y₃)) of fusion data and parameter information corresponding to the signature unit (here, n=3) included in secret distributed data 1601, it is assumed that one of the sets (the set of (X₂, Y₂)) has been lost.

Even in such a case, the data verification apparatus 140 can receive a k number (here, k=2) of sets of fusion data and parameter information as secret distributed data, and therefore the data verification apparatus 140 can calculate the secret information (α₀). That is, even when data loss occurs in the secret distributed data 1601, signature verification can be performed on the secret distributed data 1601.

Note that when data loss occurs in the secret distributed data 1601, even if data loss has not occurred in voice data 1602, there is no secret distributed data to be compared with the voice data (A₃, A₄, A₅) in the corresponding section.

However, when the following conditions are satisfied, the voice data verifying unit 1309 determines that falsification has not been performed on the voice data (A₃, A₄, A₅) in the corresponding section.
It is determined that the secret distributed data 1601 has not been falsified.
It is determined that falsification has not been performed on the voice data (A₁, A₂, A₆, A₇) in predetermined sections in the voice data 1602.
It is determined that falsification has not been performed on the information indicating the association between the voice data (A₁, A₂, A₆, A₇) in predetermined sections in the voice data 1602 and the imaging data (V₁, V₃) in the corresponding sections.

Note that when it is determined that falsification has not been performed on the voice data (A₃, A₄, A₅) in the corresponding section, the voice data verifying unit 1309 can recognize that there is imaging data in a predetermined section that has been lost, between the imaging data (V₁) and the imaging data (V₃) in predetermined sections. In this case, the voice data verifying unit 1309 can recognize that the loss in the imaging data in the predetermined section has not occurred due to falsification.

Conversely, as illustrated in FIG. 163, it is assumed that a loss has not occurred in secret distributed data 1611, but a loss has occurred in a part of voice data 1612. In such a case, in the data verification apparatus 140, it is needless to say that signature verification can be performed on the secret distributed data 1611. Also in the voice data verifying unit 1309, it is possible to verify whether falsification has been performed with respect to voice data (A₁, A₂, A₅, A₇) in predetermined sections. Furthermore, it is possible to verify whether falsification has been performed with respect to the information indicating the association with the imaging data (V₁, V₃) in the corresponding sections.

Note that in such a case, the voice data verifying unit 1309 can recognize that a loss has occurred in the voice data in a section corresponding to the imaging data (V₂) in a predetermined section. Furthermore, the voice data verifying unit 1309 can recognize that the loss in the voice data in the section has not occurred due to falsification.

### (2) Example of Falsification of Secret Distributed Data or Voice Data

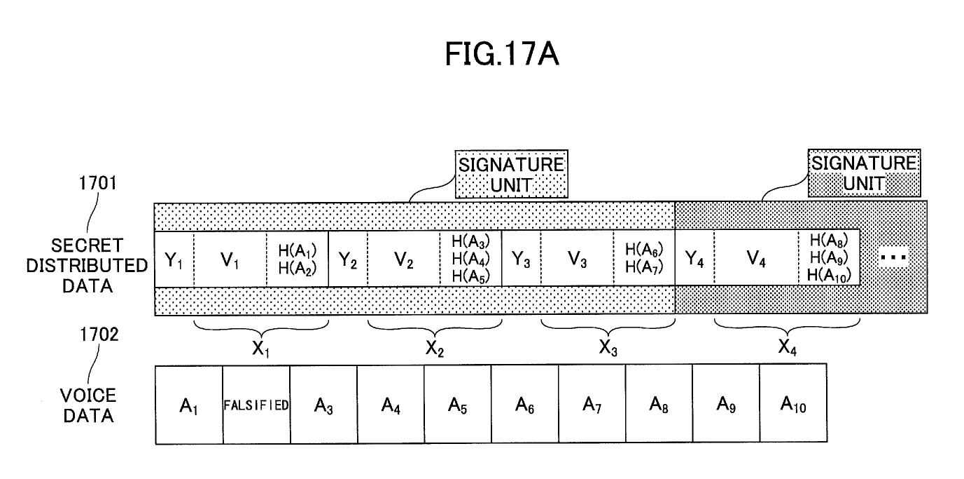

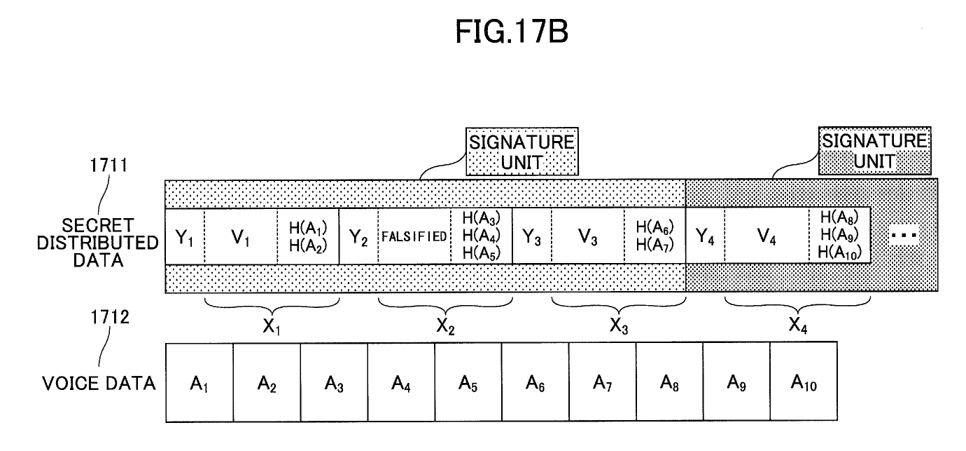

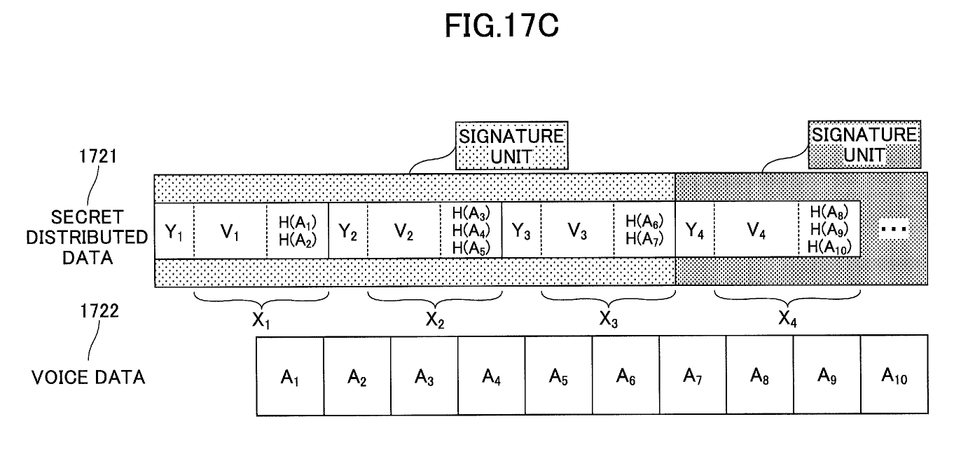

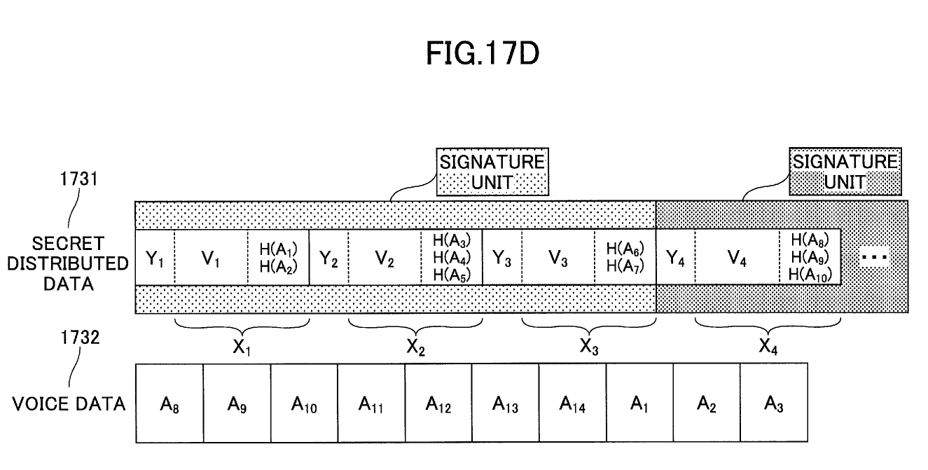

Next, examples will be described in which the secret distributed data or the voice data has been falsified. FIGS. 17A through 17D are diagrams illustrating examples of falsification on secret distributed data or voice data.

As illustrated in FIG. 17A, it is assumed that the voice data (A₂) in a predetermined section in voice data 1702 has been falsified. In this case, when it is assumed that secret distributed data 1701 has not been falsified, the voice hash data (H(A₂)) incorporated in the secret distributed data 1701 and the voice hash data obtained by hashing the voice data (A₂) in the predetermined section, do not match.

Accordingly, the voice data verifying unit 1309 can determine that the voice data (A₂) in the predetermined section in the voice data 1702 has been falsified.

On the other hand, as illustrated in FIG. 17B, it is assumed that the imaging data (V₂) in a predetermined section in secret distributed data 1711 has been falsified. In this case, the secret information (α₀) calculated based on the secret distributed data 1711 and the secret information (α₀) calculated based on the signature value (S) do not match.

Accordingly, the voice data verifying unit 1309 can determine that the secret distributed data 1711 has been falsified.

On the other hand, as illustrated in FIG. 17C, it is assumed that the information indicating the association between secret distributed data 1721 and voice data 1722 has been falsified, by shifting the entire voice data 1722 with respect to the secret distributed data 1721. In this case, the voice data 1722 itself has not been falsified, and therefore by the falsification prevention technique of the related art, it has not been possible to detect this falsification. Conversely, in the present embodiment, the secret distributed data 1721, which is a combination of the imaging data in a predetermined section and voice hash data in a corresponding section, and the voice data 1722 are compared, and therefore it is possible to detect such as falsification.

Furthermore, as illustrated in FIG. 17D, it is assumed that the information indicating the association between secret distributed data 1731 and voice data 1732 has been falsified by replacing the voice data 1732 with respect to the secret distributed data 1731 in the signature unit. In this case, the voice data 1732 has not been falsified in the signature unit, and therefore by the falsification prevention technique of the related art, it has not been possible to detect the falsification. Conversely, in the present embodiment, the secret distributed data 1731, which is a combination of the imaging data in a predetermined section and voice hash data in a corresponding section, and the voice data 1732 are compared, and therefore it is possible to detect such a falsification.

### 10. Summary—First Embodiment

As is apparent from the above description, the data distribution system according to the present embodiment has the following features.
The data distribution apparatus generates fusion data (Xᵢ) corresponding to a signature unit (n) based on the imaging data in a predetermined section and voice hash data in a corresponding section. Furthermore, the data distribution apparatus calculates parameter information (Yᵢ) satisfying the (k−1)th degree polynomial including a k (1≤k<n) number of random values, based on the generated fusion data (Xᵢ) corresponding to the signature unit (n).
The data distribution apparatus distributes by streaming, to the data verification apparatus, the secret distributed data (Xᵢ, Yᵢ) corresponding to a signature unit (n) in which the generated fusion data (Xᵢ) and the parameter information (Yᵢ) are associated with each other, and the voice data (Aⱼ) in a corresponding section.
The data distribution apparatus calculates the signature value (S) by adding a signature to the secret information (α₀) that can be calculated by accumulating a k number of secret distributed data items (Xᵢ, Yᵢ), and distributes the calculated signature value (S) to the data verification apparatus.

Accordingly, in the data verification apparatus, when a k number of secret distributed data items can be received, among the secret distributed data corresponding to the signature unit (n) distributed by streaming by the data distribution apparatus, it is possible to calculate secret information based on the k number of secret distributed data items. That is, according to the data distribution system according to the present embodiment, a (n−k) number of data losses are allowable.

Furthermore, in the data verification apparatus, by comparing the secret information with secret information calculated from the signature value distributed by the data distribution apparatus, it is possible to perform signature verification and assure the authenticity of the secret distributed data. That is, in the data verification apparatus, it is possible to perform signature verification and assure the authenticity of the secret distributed data, even when a part of the secret distributed data distributed by the data distribution apparatus is lost. As a result, it is possible to assure the authenticity of the imaging data that has been distributed by streaming.

Furthermore, in the data verification apparatus, by comparing the secret distributed data whose authenticity is assured with voice data, it is possible to determine whether the voice data itself that has been distributed by streaming has been falsified, and assure the authenticity of the voice data. Furthermore, in the data verification apparatus, it is possible to determine whether the information, which indicates the association between imaging data in a predetermined section and voice data in a corresponding section, has been falsified, and assure authenticity of the information indicating the association between imaging data in a predetermined section and voice data in a corresponding section.

As described above, according to the present embodiment, it is possible to assure the authenticity of the time series data groups to be distributed by streaming.

### Second Embodiment

In the first embodiment, the data distribution apparatus 130 and the data verification apparatus 140 execute predetermined processes. However, the method of executing the processes by the data distribution apparatus 130 and the data verification apparatus 140 is not limited to the above; the processes may be executed upon appropriately changing settings based on instructions from the administrator of the data distribution system 100. Hereinafter, a second embodiment will be described, mainly with respect to the differences from the first embodiment.

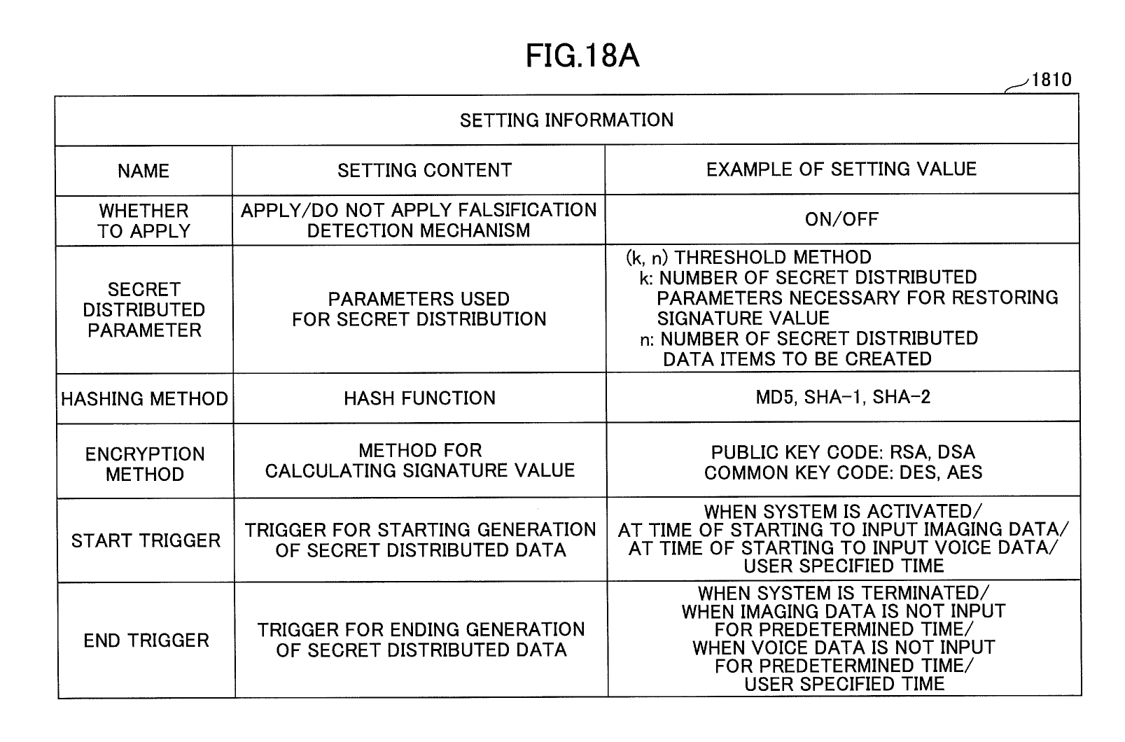

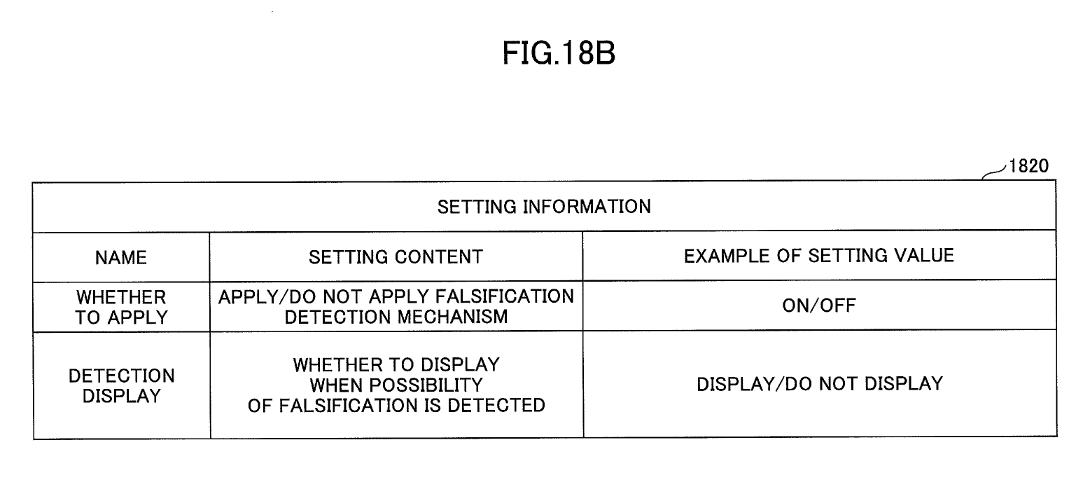

FIGS. 18A and 18B are diagrams illustrating setting information that can be changed by an administrator of the data distribution system. FIG. 18A illustrates an example of setting information 1810 of the data distribution apparatus 130 that can be changed by the administrator of the data distribution system 100. As illustrated in FIG. 18A, the setting information 1810 includes “name”, “setting content”, and “example of setting value” as information items.

In the “name”, the setting target to be changed in the data distribution apparatus 130 is stored. The example in FIG. 18A indicates that the following are included in “name”.
“Whether to apply” for setting whether to apply a falsification detection mechanism to the data distribution apparatus 130.
“Secret distributed parameter” for setting parameters used when applying a secret distributed protocol.
“Hashing method” for setting a hash function for hashing.
“Encryption method” for setting the calculation method for calculating the signature value.
“Start trigger” for setting a trigger for starting the generation of secret distributed data.
“End trigger” for setting the trigger for ending the generation of secret distributed data.

Note that according to the example in FIG. 18A, the administrator of the data distribution system 100 can select the setting value ON” or “OFF” for “whether to apply”. Furthermore, the administrator of the data distribution system 100 can set the setting value “k” or “n” for “secret distributed parameter”. Furthermore, the administrator of the data distribution system 100 can select “MD5”, “SHA-1”, or “SHA-2”, etc., for “hashing method”. Furthermore, the administrator of the data distribution system 100 can select “RSA”, “DSA”, “DES”, or “AES”, etc., for “encryption method”. Furthermore, the administrator of the data distribution system 100 can select “when system is activated”, “at the time of starting to input imaging data”, “at the time of starting to input voice data”, or “user specified time”, etc., for “start trigger”. Furthermore, the administrator of the data distribution system 100 can select “when the system is terminated”, “when imaging data is not input for predetermined time”, “when voice data is not input for predetermined time”, and “user specified time”, etc., for “end trigger”.

On the other hand, FIG. 18B illustrates an example of setting information 1820 of the data verification apparatus 140 whose setting can be changed by the administrator of the data distribution system 100. As illustrated in FIG. 18B, the setting information 1820 includes “name”, “setting content”, and “example of setting value” as items of information.

In the “name”, the setting target to be changed in the data verification apparatus 140 is stored. The example in FIG. 18B indicates that the following are included in “name”.
“Whether to apply” for setting whether to apply a falsification detection mechanism to the data verification apparatus 140.
“Detection display” for setting the display method when falsification is detected.

Note that according to the example of FIG. 18B, the administrator of the data distribution system 100 can select the setting value “ON” or “OFF” for “whether to apply”. Furthermore, the administrator of the data distribution system 100 can select “display” or “do not display” for “detection display”.

As is apparent from the above description, according to the data distribution system according to the present embodiment, the setting information for the data distribution apparatus and the setting information for the data verification apparatus can be changed based on the instructions of the administrator.

### Third Embodiment

In the first and second embodiments, the data distribution apparatus 130 acquires the imaging data and the voice data as time series data, and incorporates voice hash data obtained by hashing the voice data into the imaging data, to generate fusion data. However, the combination of the time series data is not limited to the imaging data and the voice data. For example, it is possible to acquire imaging data and temperature data, and incorporate temperature hash data, which is obtained by hashing the temperature data, in the imaging data, to generate fusion data. In this case, the data distribution apparatus 130 distributes secret distributed data based on the generated fusion data, the temperature data, and a signature value, as distribution data.

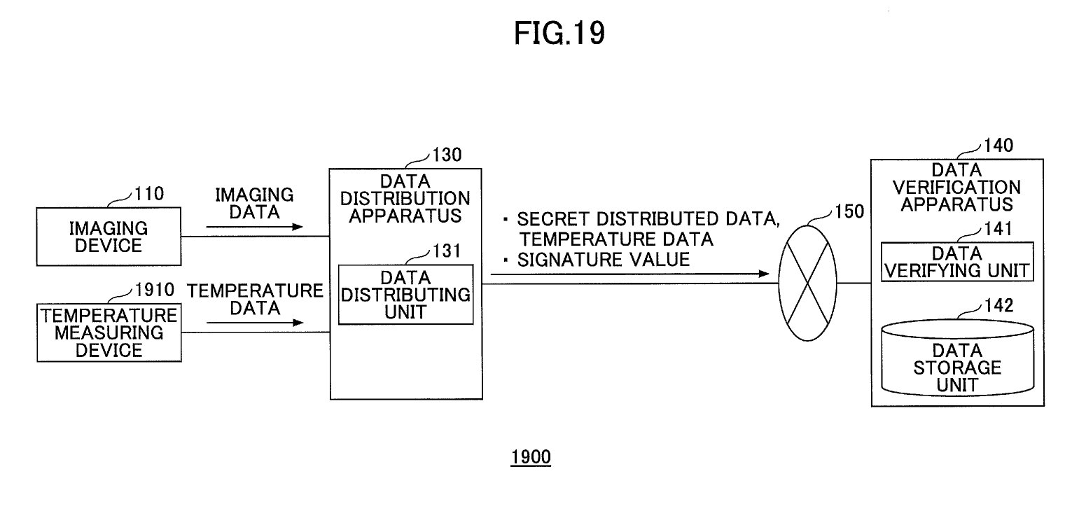

FIG. 19 is a diagram illustrating another example of the system configuration of the data distribution system. The difference from FIG. 1 is that in the case of a data distribution system 1900, a temperature measuring device 1910 is connected to the data distribution apparatus 130, instead of the voice input device 120.

As described above, even when time series data other voice data is combined with imaging data, by performing the same process, it is possible to attain the same effects as those of the first embodiment.

Furthermore, in the first and second embodiments, the fusion data is generated by acquiring two time series data items, hashing one of the time series data items, and incorporating the hashed time series data item into the other time series data item. However, the number of time series data items to be combined is not limited to two; three or more time series data items may be combined.

For example, it is possible to generate fusion data by acquiring imaging data, voice data, and temperature data, and incorporating voice hash data, which is obtained by hashing the voice data, and temperature hash data, which is obtained by hashing the temperature data, into the imaging data. In this case, the data distribution apparatus 130 distributes the secret distributed data based on the generated fusion data, the voice data, the temperature data, and a signature value, as distribution data.

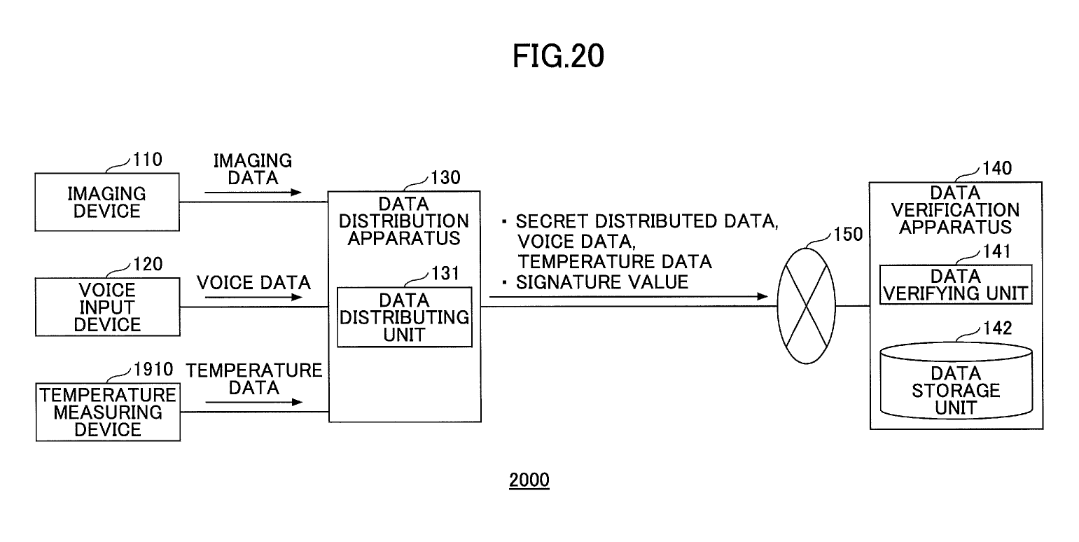

FIG. 20 is a diagram illustrating yet another example of the system configuration of the data distribution system. The difference from FIG. 1 is that in the case of a data distribution system 2000, in addition to the voice input device 120, the temperature measuring device 1910 is connected to the data distribution apparatus 130.

As described above, even when two time series data items are combined with imaging data, by performing the same process, it is possible to attain the same effects as those of the first embodiment.

Furthermore, in the first and second embodiments, the fusion data is generated by acquiring different types of time series data items, hashing one type of time series data, and incorporating the hashed time series data into the other type of time series data. However, the time series data items are not limited being different types, and the time series data items may of the same type.

For example, fusion data may be generated by acquiring two imaging data items, hashing one of the imaging data items, and incorporating the hashed imaging data item into the other imaging data item. In this case, the data distribution apparatus 130 distributes the secret distributed data based on the generated fusion data, one of the imaging data items, and a signature value, as distribution data.

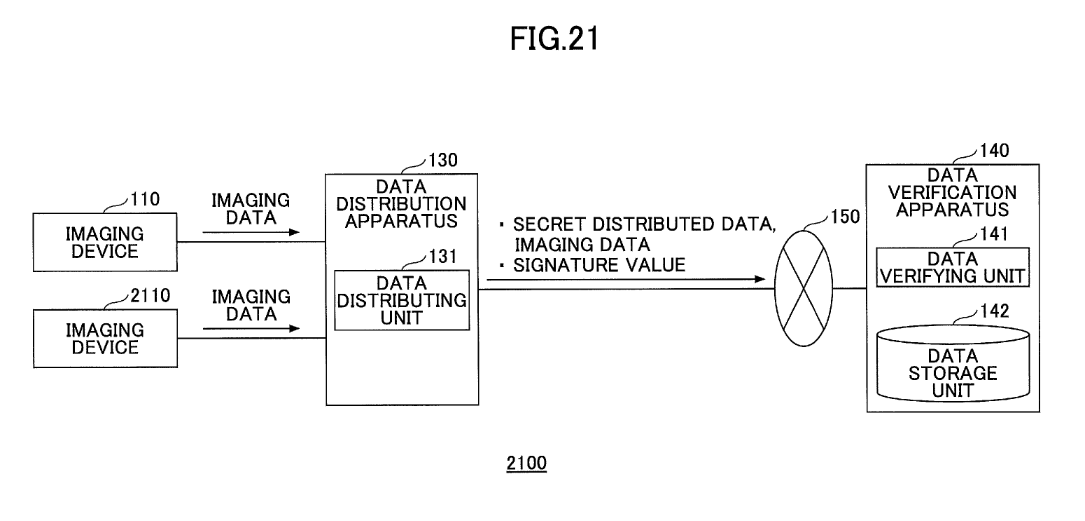

FIG. 21 is a diagram illustrating yet another example of the system configuration of the data distribution system. The difference from FIG. 1 is that in the case of a data distribution system 2100, an imaging device 2110 is connected to the data distribution apparatus 130, instead of the voice input device 120.

As described above, even when two time series data items of the same type are combined, by performing the same process, it is possible to attain the same effects as those of the first embodiment.

### OTHER EMBODIMENTS

In the first to third embodiments, the data counter unit 704 is provided to calculate a signature value (S) for imaging data items (Vᵢ) in an n number of predetermined sections. However, the timing of calculating a signature value may not be for imaging data items (Vᵢ) in an n number of predetermined sections. For example, the signature value may be calculated for imaging data items (Vᵢ) within a predetermined time.

Furthermore, in the first to third embodiments, the fusion data is generated by hashing and incorporating time series data; however, a process other than hashing may be performed as long as the process is for converting data into data indicating time series data.

Furthermore, in the first to third embodiments, a case of applying a secret distributed protocol has been described; however, it is also possible to calculate a signature value according to the fusion data without using the secret distributed protocol. In this case, the distribution data generating unit 605 outputs the fusion data, the voice data of the corresponding section, and the signature value as distribution data.

According to one embodiment of the present invention, it is possible to assure the authenticity of time series data groups that are distributed by streaming.

The data distribution apparatus and the data distribution system are not limited to the specific embodiments described in the detailed description, and variations and modifications may be made without departing from the spirit and scope of the present invention.

What is claimed is:

1. A data distribution apparatus comprising a first processor, in communication with a first memory, executing a first process including:
generating fusion data by incorporating, in a metadata area in first time series data in a predetermined section, first hash data obtained by hashing second time series data in a corresponding section;
calculating a signature value according to a plurality of pieces of the fusion data; and
outputting the fusion data, the second time series data in the corresponding section, and the signature value.

2. The data distribution apparatus according to claim 1, the first process further including:
calculating a plurality of pieces of parameter information satisfying a (k−1)th degree polynomial including a k number of values, based on the plurality of pieces of the fusion data, the k being an integer of one or more and less than n, wherein
the calculating of the signature value includes calculating the signature value according to the plurality of pieces of the fusion data and the parameter information.

3. The data distribution apparatus according to claim 2, wherein
the calculating of the signature value includes calculating the signature value based on secret information based on a secret distributed protocol, the secret information being calculated by accumulating the k number of sets of the fusion data and the parameter information, and
the outputting includes outputting the sets of the fusion data and the parameter information, the second time series data in the corresponding section, and the signature value.

4. The data distribution apparatus according to claim 3, wherein
the calculating of the plurality of pieces of parameter information includes assigning a summed value to the (k−1)th degree polynomial, to calculate each of the plurality of pieces of parameter information, the summed value being obtained by summing the first time series data in the predetermined section and the first hash data obtained by hashing the second time series data in the corresponding section included in the fusion data.

5. A data verification apparatus connected to the data distribution apparatus according to claim 1, the data verification apparatus comprising a second processor, in communication with a second memory, executing a second process including:
generating second hash data by hashing the second time series data in the corresponding section output from the data distribution apparatus; and
determining whether the first hash data, which is included in the fusion data output from the data distribution apparatus, and the second hash data, which is generated by the data verification apparatus, match with each other.

6. A data distribution system comprising:
a data distribution apparatus; and
a data verification apparatus connected to the data distribution apparatus, wherein
the data distribution apparatus includes a first processor, in communication with a first memory, executing a first process including:
generating fusion data by incorporating, in a metadata area in first time series data in a predetermined section, first hash data obtained by hashing second time series data in a corresponding section;
calculating a plurality of pieces of parameter information satisfying a (k−1)th degree polynomial including a k number of values, based on a plurality of pieces of the fusion data, the k being an integer of one or more and less than n;
calculating a signature value based on first secret information based on a secret distributed protocol, the first secret information being calculated by accumulating the k number of sets of the fusion data and the parameter information; and
outputting the sets of the fusion data and the parameter information, the second time series data in the corresponding section, and the signature value, and wherein
the data verification apparatus includes a second processor, in communication with a second memory, executing a second process including:
calculating second secret information based on the secret distributed protocol, in response to the k number of the sets of the fusion data and the parameter information being output from the data distribution apparatus; and
determining whether the first secret information, which is calculated based on the signature value output from the data distribution apparatus, and the second secret information, which is calculated by the data verification apparatus, match with each other.

7. The data distribution system according to claim 6, the second process executed in the data verification apparatus further including:
generating second hash data by hashing the second time series data in the corresponding section output from the data distribution apparatus, in response to determining that the first secret information and the second secret information match with each other; and
determining whether the first hash data, which is included in the fusion data output from the data distribution apparatus, and the second hash data, which is generated by the data verification apparatus, match with each other.

8. The data distribution system according to claim 7, the second process executed in the data verification apparatus further including:
determining that the second time series data in the corresponding section is not falsified, in response to determining that the first hash data and the second hash data match with each other.

9. A data distribution system comprising:
a data distribution apparatus; and
a data verification apparatus connected to the data distribution apparatus, wherein
the data distribution apparatus includes a first processor, in communication with a first memory, executing a first process including:
generating fusion data by incorporating, in a metadata area in first time series data in a predetermined section, first hash data obtained by hashing second time series data in a corresponding section;
calculating a signature value according to a plurality of pieces of the fusion data; and
outputting the fusion data, the second time series data in the corresponding section, and the signature value, and wherein
the data verification apparatus includes a second processor, in communication with a second memory, executing a second process including:
generating second hash data by hashing the second time series data in the corresponding section output from the data distribution apparatus; and
determining whether the first hash data, which is included in the fusion data output from the data distribution apparatus, and the second hash data, which is generated by the data verification apparatus, match with each other.
